(19) United States
(12) Patent Application Publication
(10) Pub. No.: US 2006/0130316 A1
(43) Pub. Date: Jun. 22, 2006

(54) Magnetic disk drive manufacturing method, test/adjustment apparatus, and transport container

(75) Inventors: Makoto Takase, Kanagawa (JP); Keiichiroh Kai, Kanagawa (JP); Shigemi Suganuma, Kanagawa (JP); Hiroshi Nagasawa, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/313,080

(22) Filed: Dec. 19, 2005

(30) Foreign Application Priority Data
Dec. 21, 2004 (JP) 2004-369029

(51) Int. Cl. G11B 5/127; G01N 27/82; B23P 19/00

(52) U.S. Cl. 29/603.09; 29/603.03; 29/737; 324/213

(57) ABSTRACT

The present invention provides an improved magnetic disk drive manufacturing method that is to be employed during an interval between magnetic disk drive assembly completion and shipment. In one embodiment, a magnetic disk drive has an interface connector. The magnetic disk drive is retained by a shock absorber so that the interface connector is exposed. A testing side connector mounted on a base plate is connected to the interface connector of the magnetic disk drive that is retained by the shock absorber. A host apparatus transfers a test/adjustment program to the magnetic disk drive via the testing side connector. The magnetic disk drive executes the test/adjustment program.

### CROSS-REFERENCES TO RELATED APPLICATIONS

This application claims priority from Japanese Patent Application No. JP2004-369029, filed Dec. 21, 2004, the entire disclosure of which is incorporated herein by reference.

### BACKGROUND OF THE INVENTION

The present invention relates to a magnetic disk drive manufacturing method, test/adjustment apparatus, and transport container, and more particularly to a technology for simplifying a manufacturing process that is to be performed during an interval between magnetic disk drive assembly completion and shipment.

The process for assembling a magnetic disk drive is performed by mounting a magnetic disk, actuator, and other component parts on a base, installing a base cover over the base, and mounting a circuit board on an enclosure, which comprises the base and base cover. During a time interval between the instant at which the magnetic disk drive hardware is completely assembled and the instant at which the magnetic disk drive is finished and readied for shipment, it is necessary to write servo information onto a magnetic disk, adjust a control circuit, optimize parameters, conduct an operational check, and perform various other test/adjustment procedures. Formerly, these test/adjustment procedures were performed with a dedicated testing apparatus.

The dedicated testing apparatus comprised a chamber, which contained many cells for mounting magnetic disk drives, and a testing computer, which was connected to the chamber. During a time interval between the instant at which the magnetic disk drives were completely assembled and the instant at which the assembled magnetic disk drives were placed in corrugated cardboard boxes and shipped out of factory, the magnetic disk drives were individually placed on a carriage and moved for the purpose of performing the above-mentioned test/adjustment procedures. However, when the magnetic disk drives were to be mass-produced, the use of the above method increased the amount of investment in the testing apparatus and the time required for the execution of the test/adjustment procedures. In addition, some magnetic disk drives became defective when they bumped against something or dropped during transit.

FIG. 16 shows a conventional transport container 1 that is used to pack a plurality of assembled magnetic disk drives 4 for shipment. Each magnetic disk drive 4 is placed in a compartment that is formed in a shock absorber 3. The magnetic disk drives 4 are held with the interface connector mounting surface facing downward. The magnetic disk drives 4 and shock absorber 3 are marked with barcodes, which indicate the delivery destination and identify the magnetic disk drives, packed into a corrugated cardboard box 2, and shipped to users.

### BRIEF SUMMARY OF THE INVENTION

The applicant of the present invention previously filed an application, Japanese Patent Application No. 2004-78569, disclosing a technology for using a magnetic disk drive, which has gone through with an optimization/inspection process, as a testing apparatus by operating it in a host mode to transfer files to another magnetic disk drive and perform tests. The applicant of the present invention also filed an application, Japanese Patent Application No. 2004-200347, disclosing a technology concerning a test controller, which permits a magnetic disk drive under test to locally perform test/adjustment procedures without being limited by the size and characteristics of a test/adjustment program, and makes it possible to test magnetic disk drives that employ the ATA interface.

When a test/adjustment method disclosed by the above-mentioned previously filed patent applications is to be actually applied to a magnetic disk drive manufacturing process, it is necessary, for instance, to reduce the amount of investment in a testing apparatus and increase the yield rate prevailing between assembly completion and shipment. The transport container was merely used to pack finished magnetic disk drives. It is convenient, however, that the transport container be also used in the magnetic disk drive manufacturing process.

It is a feature of the present invention to provide an improved magnetic disk drive manufacturing method for use during an interval between assembly completion and shipment. It is another feature of the present invention to provide a test/adjustment apparatus and transport container for use with such a manufacturing method.

According to a first aspect of the present invention, there is provided a manufacturing method for manufacturing a magnetic disk drive equipped with an interface connector. The manufacturing method comprises the steps of: holding a plurality of magnetic disk drives with a shock absorber so that the interface connector is exposed; connecting testing side connectors, which are arranged to match the held interface connectors, to the interface connectors; transferring a test/adjustment program from a host apparatus to the magnetic disk drives via the testing side connectors; and causing the magnetic disk drives to execute the test/adjustment program.

The magnetic disk drive manufacturing method according to embodiments of the present invention uses three processes. The first process relates to hardware assembly. The second process is performed to write servo data onto a magnetic disk, check for defects, adjust and optimize control circuit parameters, and incorporate functions while conducting, for instance, operational checks. The third process is performed to pack magnetic disk drives, which have incorporated functions, and make them ready for shipment. The second process is also referred to as the test/adjustment process.

The plurality of magnetic disk drives to be subjected to the test/adjustment process are held by the shock absorber so that the interface connectors are exposed. Therefore, it is possible to connect all the testing side connectors, which are mounted on a base plate, to the interface connectors, send the test/adjustment program, and have the magnetic disk drives execute the test/adjustment program. Since the magnetic disk drives are held by the shock absorber, they do not bump against something, drop, or become damaged during the test/adjustment process. Further, the productivity increases because a plurality of magnetic disk drives may be simultaneously handled.

The test/adjustment program includes, for instance, a program for writing servo information into a magnetic disk drive by a self servo write method and a command test, which is performed relative to the host apparatus. When a magnetic disk drive that is capable of operating in a host mode is employed as the host apparatus, it is not necessary to use a testing computer, thereby reducing the amount of investment in the test/adjustment process. When an RFID tag is attached to the shock absorber, it is possible to cover a plurality of magnetic disk drives with one tag and gather dynamic information about errors encountered in the test/adjustment process and the progress of the process for management purposes.

When the test/adjustment process is performed while the shock absorber and the magnetic disk drives held by the shock absorber are positioned in a shipment transport box, there is no need to use a chamber or other storage facilities for the test/adjustment process. It is also possible to simplify a magnetic disk drive transport operation that is to be performed in a factory.

According to a second aspect of the present invention, there is provided a test/adjustment apparatus for testing a plurality of magnetic disk drives whose interface connectors are oriented in the same direction. The test/adjustment apparatus comprises a base plate; a plurality of testing side connectors that are mounted on one surface of the base plate to match the interface connectors and connectable to the interface connectors; a host side connector that is connected to each of the testing side connectors and mounted on the base plate so as to be connectable to a host apparatus; and a guide plate for prescribing the positions of the interface connectors, which correspond to the positions of the testing side connectors.

The host side connector may be connected to transmission paths that conform to various interface standards, such as an ATA transmission path, SCSI transmission path, and Fibre Channel transmission path. When the guide plate is used in conjunction with the base plate, the testing side connectors may be connected to many magnetic disk drives whose interface connectors are oriented in the same direction. During the test/adjustment process, the magnetic disk drives may be held by the shock absorber that is positioned in the shipment transport box.

According to a third aspect of the present invention, there is provided a transport container for use in the manufacture and shipment of a magnetic disk drive that has an interface connector on a lateral surface of a disk enclosure. The transport container comprises a shock absorber for holding a plurality of magnetic disk drives so that the interface connector protrudes above an upper end; and a transport box that may contain the shock absorber for retaining the plurality of magnetic disk drives.

### BRIEF DESCRIPTION OF THE DRAWINGS

FIG. 1 is a block diagram illustrating major components of a magnetic disk drive according to one embodiment of the present invention.

FIG. 2 is a perspective view that outlines a jumper block and jumper connector of a magnetic disk drive.

FIG. 3 shows a connection that is to be made for a direct file transfer between a parent magnetic disk drive and a child magnetic disk drive.

FIG. 4 is a flowchart illustrating the steps to be performed for making a direct file transfer between a parent magnetic disk drive and a child magnetic disk drive.

FIG. 5 illustrates a connection for making a direct file transfer between a parent magnetic disk drive and a child magnetic disk drive upon command from a host computer.

FIG. 6 is a flowchart illustrating a procedure that is performed to make a direct file transfer between a parent magnetic disk drive and a child magnetic disk drive upon command from a host computer.

FIG. 7 illustrates a connection scheme for generating a clone by making a direct file transfer between magnetic disk drives.

FIG. 8 is a flowchart illustrating a procedure for generating a clone by making a direct file transfer between magnetic disk drives.

FIG. 9 illustrates a connection scheme for performing an optimization/inspection process between magnetic disk drives.

FIG. 10 is a flowchart illustrating a procedure for performing an optimization/inspection process between magnetic disk drives.

FIG. 11 shows a situation where a host computer is connected to magnetic disk drives via Fibre Channel or fabric switch.

FIG. 12 illustrates a basic execution environment for performing a test/adjustment process on a magnetic disk drive.

FIG. 13 is a flowchart illustrating a basic test/adjustment procedure.

FIG. 14 illustrates the configuration of a test controller conforming to the ATA standard.

FIG. 15 is a flowchart illustrating how a test/adjustment procedure is performed with the test controller.

FIG. 16 is a perspective view illustrating a conventional transport container that comprises a shock absorber and transport box and is used for magnetic disk drive shipment.

FIGS. 17(A) and 17(B) are perspective views illustrating a transport container according to one embodiment of the present invention, which comprises a shock absorber and transport box and is used for magnetic disk drive shipment.

FIG. 18 is a plan view illustrating a test/adjustment apparatus base plate.

FIG. 19 is a plan view illustrating a test/adjustment apparatus guide plate.

FIG. 20 is a cross-sectional view illustrating how a test/adjustment apparatus is mounted on a transport container.

FIG. 21 is a flowchart illustrating a magnetic disk drive manufacturing method.

### DETAILED DESCRIPTION OF THE INVENTION

Description of a Method for Switching into a Host Mode and the Like

First of all, a magnetic disk drive that may safety alternate between a host mode and device mode, which were operating modes proposed by a previous patent application, and a magnetic disk drive that operates in the host mode to transfer data directly to another magnetic disk drive or perform an optimization/inspection process will be described. Within this document, the meaning of the term “optimization/inspection process” is the same as that of the test/adjustment process.

Description of a Magnetic Disk Drive

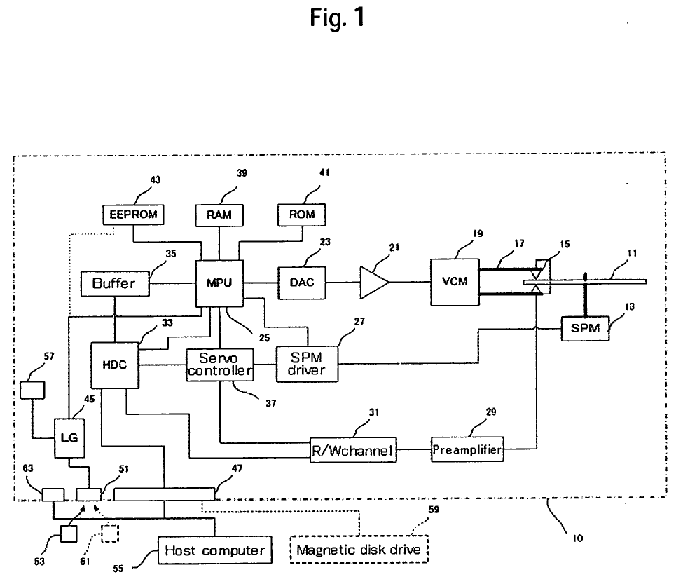

FIG. 1 is a block diagram illustrating major components of a magnetic disk drive 10. The magnetic disk drive 10 has two operation modes: host mode and device mode. In the host mode, the magnetic disk drive operates like a host computer for another magnetic disk drive. More specifically, the magnetic disk drive in the host mode actively accesses another magnetic disk drive, for instance, to perform a file read/file write operation or make adjustments. The device mode is a normal operation mode in which the magnetic disk drive receives a command from a host computer or a magnetic disk drive operating in the host mode and passively operates to perform a file read/file write operation or make adjustments.

The magnetic disk drive 10 is capable of operating in the host mode. However, when the magnetic disk drive 10 operates in the device mode, the user may use it as a regular magnetic disk drive. Within this document, the term “files” may refer to any information possessed by the magnetic disk drive, such as user data, system data, firmware and programs concerning the operation of the magnetic disk drive, and identification and adjustment parameters for the magnetic disk drive. The files may be stored on a magnetic disk or in a nonvolatile semiconductor memory.

In the host mode, the magnetic disk drive 10 operates as a parent magnetic disk drive. In the device mode, on the other hand, the magnetic disk drive 10 operates as a child magnetic disk drive. Both surfaces of the magnetic disk 11, which is used as a recording medium, serve as a recording surface on which a magnetic layer is formed. One magnetic disk or a set of two or more stacked magnetic disks is installed over a spindle hub and rotated by a spindle motor 13 (hereinafter referred to as the SPM). Tracks are concentrically formed on the recording surfaces of the magnetic disk 11. Each track is circumferentially divided into sectors or blocks, which serve as data read/data write units.

For each sector, a physical block address (PBA) and logical block address (LBA) are defined. The physical block address relates to the physical position of the magnetic disk 11. The logical block address is recognized by the host computer as a file position within a logical sequence. A head 15 provides bidirectional conversion between electrical signals and magnetic signals. It comprises independent conversion elements that perform write and read operations in relation to the magnetic disk 11 or comprises a common conversion element. An actuator assembly 17 turns while supporting the head 15, and carries the head 15 to a location above a specified track of the magnetic disk 11.

A voice coil motor 19 (hereinafter referred to as the VCM) comprises a voice coil, which is mounted on the actuator assembly 17, and a voice coil magnet and voice coil yoke, which are mounted on a base of the magnetic disk drive 10. The current flowing to the voice coil is used to control the operation of the actuator assembly 17. A VCM driver 21 receives a voltage signal from a digital-to-analog converter 23 (hereinafter referred to as the DAC) and converts the received voltage signal to a drive current for the VCM 19. The DAC 23 receives a digital signal for positioning the head 15 from a microprocessing unit 25 (hereinafter referred to as the MPU), and converts the received digital signal to an analog voltage signal.

A spindle motor driver 27 (hereinafter referred to as the SPM driver) includes an analog-to-digital converter and converts a digital signal, which is received from the MPU 25, to a drive current for the SPM 13. A preamplifier 29 amplifies a feeble analog read signal, which is read from the magnetic disk 11 by the head 15 at the time of a read, and forwards the amplified signal to a read/write channel 31 (hereinafter referred to as the R/W channel). Further, the preamplifier 29 receives an analog write signal at the time of a write, amplifies the received signal, and outputs the amplified signal to the head 15.

The R/W channel 31 performs a data process for a write or read. Write digital data, which is transmitted from a host computer 55 to the magnetic disk drive 10, is received by the R/W channel 31 via a hard disk controller 33 (hereinafter referred to as the HDC). The R/W channel 31 converts the received digital data to a write current and forwards the resulting write current to the preamplifier 29. A head read signal, which is transmitted from the preamplifier 29 to the R/W channel 31, is converted to digital data by the R/W channel 31 and forwarded to the host computer 55 via the HDC 33. A servo controller 37 extracts the position information about the head from the read data that is output from the R/W channel 31, and forwards the extracted position information to the MPU 25 and HDC 33.

The HDC 33 functions as an interface for communicating with the host computer 55, and adjusts the speed of data transfer to/from the host computer 55 and the data processing speed prevailing within the magnetic disk drive 10. The HDC 33 receives transfer data from the host computer 55, temporarily stores the received data in a buffer 35, and forwards the buffered data to the R/W channel 31 upon command from the MPU 25. Further, the HDC 33 receives transfer data from the R/W channel 31, temporarily stores the received data in the buffer 35, and forwards the buffered data to the host computer 55 upon command from the MPU 25. The HDC 33 includes, for instance, a data error correction circuit and an address mark detection circuit.

The HDC 33 also includes various registers for establishing data communication with the host computer 55. While the magnetic disk drive 10 operates in the device mode, a certain register receives commands and data, which conform to a specified interface standard, from the host computer 55 or a remote magnetic disk drive 59. While the magnetic disk drive 10 operates in the host mode, a certain other register sends commands and data to a remote magnetic disk drive 59.

The MPU 25 coordinates with the HDC 33 to control the overall operation of the magnetic disk drive 10. The MPU 25 directly accesses various registers of the HDC 33 to control a data transfer to/from the host computer 55 or a remote magnetic disk drive 59. The MPU 25 includes various registers for executing commands that conform to the ATA, SCSI, or other predefined standard. The MPU 25 according to the present embodiment may execute a host mode execution program to run in the host mode as well as in the device mode, and transmit commands and data to the outside.

The MPU 25 includes a status register that judges whether it operates in the host mode or in the device mode. The MPU 25 converts a logical block address (LBA) of the magnetic disk 11, which is transmitted from the host computer 55 to the magnetic disk drive 10, to a physical block address (PBA). Further, the MPU 25 determines the position of the magnetic head 15 in accordance with servo information that is transmitted from the servo controller 37 to the MPU 25, and transmits to the DAC 23 a digital signal for placing the head 15 at a target position in accordance with a difference from the target position calculated from an address that is specified by the host computer 55 or a remote magnetic disk drive 59.

A read-only semiconductor memory 41 (hereinafter referred to as the ROM) stores firmware including a host mode execution program and a device mode execution program. The host mode execution program causes the MPU 25 to execute the host mode. The device mode execution program causes the MPU 25 to execute the device mode. The host mode execution program and device mode execution program may be stored in a system data area of the magnetic disk 11. A random-access memory 39 (hereinafter referred to as the RAM) is used as a main storage device, which temporarily stores a program that is to be executed by the MPU 25 or provides a work area for the MPU 25.

An electrically erasable programmable ROM 43 (hereinafter referred to as the EEPROM) stores information specific to the magnetic disk drive 10, such as a model name, serial number, firmware version, employed protocol, and manufacturer name, and setup information concerning, for instance, power management, write or look-ahead caching, and read or write buffering. The above specific information and setup information are referred to as the drive information. The drive information may be referenced as inquiry data when the AT interface method is employed or as sense data when the SCSI interface method is employed.

Further, the EEPROM stores the data about occurrences encountered during an operation of the magnetic disk drive 10, including an error log, event log, performance data, servo log, and host log. These items of operating performance related information are referred to as the operation information. The EEPROM may also store an event flag, which indicates whether the magnetic disk drive 10 operates in the host mode or device mode, and the address or identifier of a magnetic disk drive to which files are to be transferred. The information about event flag setup and address write operations may be handled by the host computer 55 when the magnetic disk drive 10 operates in the device mode. Such information may be referenced by the processor when the magnetic disk drive 10 or MPU 25 is turned on. The EEPROM also stores the LBA information about defective sectors and alternate sectors allocated to the defective sectors.

A special jumper block 53, a general-purpose jumper block 61, a jumper connector 51, and a logic gate 45 compose an operation mode setup section for the magnetic disk drive 10. When the employed configuration is such that the event flag concerning the operation mode is set up in the EEPROM 43, the EEPROM 43 constitutes the operation mode setup section.

The generally employed jumper block configuration is such that specific jumper pins are shorted when a jumper block is connected to a jumper connector having a plurality of jumper pins. When the general-purpose jumper block 61 is mounted on the jumper connector 51, the user may operate the magnetic disk drive 10 in the device mode to perform various setup operations. For example, the jumper pins to be shorted may be selected so as to perform various function setup operations such as master/slave/cable select setup, security function enable/disable setup, or capacity limit setup.

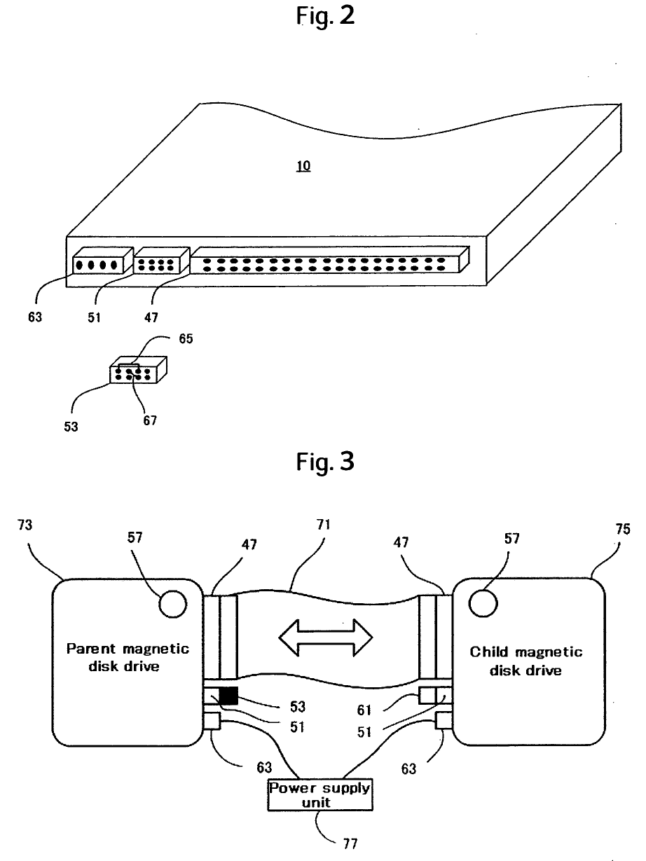

Either the general-purpose jumper block 61 or the special jumper block 53 may be mounted on the jumper connector 51 of the magnetic disk drive 10. The special jumper block 53 has a special pin layout so as to short jumper pins that are not employed by the general-purpose jumper block 61. The special jumper block 53 is therefore used to operate the magnetic disk drive 10 in the host mode and issue instructions for host mode function selection. FIG. 2 is a perspective view illustrating the jumper connector 51 and special jumper block 53. The special jumper block 53 shown in FIG. 2 is configured so as to have short pins that are not positioned adjacent to each other as indicated by the reference numeral 65 or short pins that are positioned in an oblique relationship to each other as indicated by the reference numeral 67.

The above jumper block configuration is not employed by the general-purpose jumper block 61, which is to be supplied to the user. The host mode is an operation mode that is not to be used by the user. The user cannot perform function setup for operating the magnetic disk drive 10 in the host mode unless the user uses the special jumper block 53. A DIP switch may be used in replacement of the jumper connector 51. The DIP switch provides increased convenience because it facilitates operation mode setup. However, it requires a tamperproof cover or other means for avoiding an operating error. A power supply connector 63 is positioned next to the jumper connector 51 in order to supply power to the magnetic disk drive 10.

Each connector pin on the jumper connector is connected to the logic gate 45. The logic gate 45 includes an AND gate, OR gate, and NAND gate. The logic gate 45 inputs a logic state, which is formed by short- or open-circuited connector pins provided by the special jumper block 53 or general-purpose jumper block 61, creates a new logic state, and outputs the created logic state to an I/O port of the MPU 25.

The output from the logic gate 45 may alternatively be delivered to the MPU 25 via the HDC 33. The logic state sent from the logic gate 45 to the I/O port of the MPU 25 represents a pull-up state or pull-down state of each wire connected to the I/O port. The represented state is the same as invoked when specific data is written into the status register of the MPU 25. As an alternative to the use of the logic gate 45, the jumper connector 51 may be directly connected to the I/O port of the MPU 25. The logic gate 45 functions as a decoder. Therefore, the use of the logic gate 45 makes it possible to set up an increased number of host mode functions in relation to the MPU 25.

The event flag information about operation mode setup, which is written in the EEPROM 43, may be input into the logic gate 45 or input directly into the I/O port of the MPU 25. If the EEPROM 43 constitutes the operation mode setup section, the degree of function setup freedom increases when the host computer 55 changes the contents of the event flag. Further, the event flag of the EEPROM 43 may be combined with the logic state of the logic gate 45 for function setup purposes. Increased convenience is provided when an increased number of functions may be set up. Detailed functions may be implemented for transferring data between parent and child magnetic disk drives or performing an optimization/inspection process in a situation where the magnetic disk drive 10 operates as a parent magnetic disk drive and a remote magnetic disk drive 59 operates as a child magnetic disk drive as described later.

If a password input is prompted for when the host computer 55 or a remote magnetic disk drive 59 running in the host mode attempts to write an event flag of the EEPROM 43, it is possible to prevent the user from setting an incorrect event flag. A display section 57 comprises one LED or a plurality of LEDs and is mounted on the outer surface of the enclosure. In compliance with various commands from the MPU 25, the display section 57 indicates various items of information such as the start of a data transfer, the amount of transferred data, the end of a data transfer, and an encountered error.

The host computer 55 is an electronic device that uses the magnetic disk drive 10 as an external storage device or auxiliary storage device. The host computer 55 connects to the interface connector 47 by an interface method conforming to the ATA (AT Attachment), serial ATA, SCSI (Small Computer System Interface), or Fibre Channel standard, and transfers data to/from the magnetic disk drive 10. Remote magnetic disk drives 59 have basically the same configuration as the magnetic disk drive 10 and operate in two different operation modes (host mode and device mode). However, if the remote magnetic disk drives 59 merely operate as child magnetic disk drives, they do not have to incorporate the host mode.

When the magnetic disk drive 10 operates in the device mode, it transfers files to/from the host computer 55 upon command from the host computer 55. More specifically, the magnetic disk drive 10 receives a write command and data generated by the host computer 55, writes the data at a specified address of the magnetic disk 11, receives a read command, reads data at a specified address of the magnetic disk 11, and transfers the read data to the host computer 55. This also holds true when a remote magnetic disk drive operating in the host mode is connected to the interface connector 47. When the magnetic disk drive 10 operates as a parent magnetic disk drive in the host mode, data transfer takes place with the interface connector 47 connected to a remote magnetic disk drive 59 that operates as a child magnetic disk drive in the device mode. The employed configuration may be such that two or more child magnetic disk drives are connected via a bus or daisy chain to form a data transmission path and establish data communication with the parent magnetic disk drive. If a Fibre Channel data transmission path is adopted, a peer-to-peer (point-to-point) topology, a fabric topology, an arbitrated loop topology, or a combination of these may be used as a connection scheme to permit two or more magnetic disk drives to communicate with each other.

The magnetic disk drive 10 has been described above with reference to a typical block diagram. However, individual block names, functions, and correlations, which have been described with reference to the drawings, are illustrative only. The scope of the present invention is not limited to the above description. Those skilled in the art will appreciate that it is possible to add some other functions, implement the same functions with different blocks, and divide or combine blocks without departing from the spirit and scope of the invention.

Description of a Direct File Transfer Between Parent and Child Magnetic Disk Drives

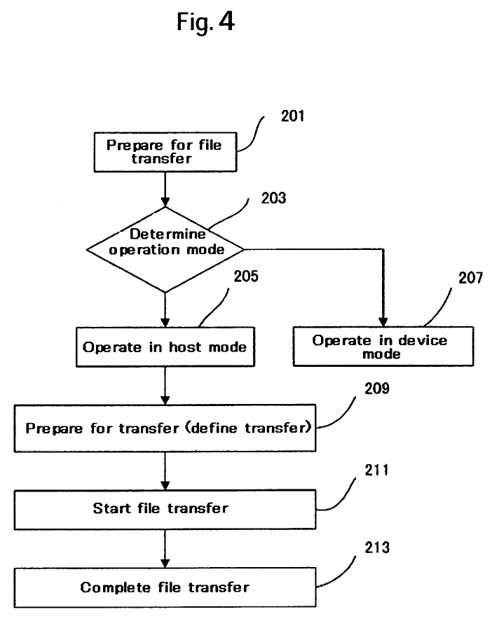

A method for directly transferring files between parent and child magnetic disk drives will now be described with reference to FIGS. 3 and 4. FIG. 3 shows a connection that is to be made for a direct file transfer between a parent magnetic disk drive 73 and a child magnetic disk drive 75. FIG. 4 is a flowchart illustrating the steps to be performed for such a direct file transfer. The parent magnetic disk drive 73 is configured in the same manner as the magnetic disk drive 10, which is described with reference to FIG. 1 and capable of operating in the host mode. The parent magnetic disk drive 73 operates actively or voluntarily in relation to the child magnetic disk drive 75 and transfers various types of data to/from the child magnetic disk drive 75.

The child magnetic disk drive 75 is a regular magnetic disk drive that passively operates in the device mode in relation to the host computer. Upon receipt of instructions from the parent magnetic disk drive 73, the child magnetic disk drive 75 operates passively. Both the parent magnetic disk drive 73 and child magnetic disk drive 75 employ the ATA interface method. The magnetic disk drive 10 that is described with reference to FIG. 1 selectively operates in either the host mode or device mode. In the present embodiment, therefore, the child magnetic disk drive 75 is configured the same as the magnetic disk drive 10 described with reference to FIG. 1 and is operative in the device mode. Both the parent magnetic disk drive 73 and child magnetic disk drive 75 comprise the display section 57, interface connector 47, jumper connector 51, and power supply connector 63. The magnetic disk drive 10 operates as either the parent magnetic disk drive 73 or child magnetic disk drive 75 depending on the type of the jumper block connected to the jumper connector 51.

Step 201 is performed to prepare for a data transfer. The special jumper block 53 is mounted on the jumper connector 51 of the parent magnetic disk drive 73 and the general-purpose jumper block 61 is mounted on the jumper connector 51 of the child magnetic disk drive 75. An ATA interface cable 71 is connected to the interface connectors 47 of the parent and child magnetic disk drives. Further, a power supply unit 77 is connected to the power supply connectors 63 of the parent and child magnetic disk drives. In FIG. 3, the two magnetic disk drives 73, 75 are directly interconnected with the ATA interface cable. However, another device may exist between the two magnetic disk drives as far as the employed configuration permits direct file transfer. In an operation performed for direct file transfer between magnetic disk drives, one magnetic disk drive runs in the host mode to actively start a file transfer operation and send files to the other magnetic disk drive or receive files from the other magnetic disk drive.

In step 203, the parent magnetic disk drive 73 and child magnetic disk drive 75 are turned on. The parent magnetic disk drive 73 does not start a transfer operation until the child magnetic disk drive 75 becomes ready for a file transfer. Therefore, the parent magnetic disk drive 73 and child magnetic disk drive 75 may be turned on in any order. When started up, the parent magnetic disk drive 73 reads a startup program from the ROM 41, initializes the registers of the MPU 25, HDC 33, and the like, and executes a startup routine to start a self-diagnostic program. Within the startup routine, the startup program always reads the status register of the MPU 25. In step 205, the MPU 25 reads the contents of the status register.

The contents of the status register represent a logic state that is invoked by the special jumper block 53 or a combination of the special jumper block 53 and logic gate 45. The contents of the status register are such that the parent magnetic disk drive 73 operates in the host mode. Further, the contents of the status register may include the settings for write transfer and read transfer, a selected transfer file type, the settings for dead copy and defrag copy modes, and the settings for the functions to be exercised by the parent magnetic disk drive 73. The defrag copy mode will be described later in detail. Selectable transfer file types include user data stored on a magnetic disk 11 of the parent magnetic disk drive 73 or child magnetic disk drive 75, firmware stored in the ROM 41, and drive information and operation information stored in the EEPROM 43.

When the MPU 25 of the parent magnetic disk drive 73 confirms that the contents of the status register indicate the host mode, the program flow proceeds to step 205. In step 205, the RAM 39 reads the host mode execution program from the ROM 41 or magnetic disk 11 so that the parent magnetic disk drive 73 starts running in the host mode. When the MPU 25 of the child magnetic disk drive 75 confirms that the contents of the status, which are determined by the general-purpose jumper block 61, indicate the device mode, the program flow proceeds to step 207. In step 207, the child magnetic disk drive 75 starts running in the device mode. The host mode execution program has all the functions for operating the MPU 25 in the host mode and transferring files to/from the child magnetic disk drive 75. The host mode operations performed by the parent magnetic disk drive 73 are determined by the settings in the operation mode setup section and the contents of the host mode execution program. In the present embodiment, a choice between the host mode and device mode is made by selecting a program that starts up upon power on. When there are a plurality of programs concerning the host mode, device mode, and other basic magnetic disk drive operations, switching from one running program to another program generally involves a risk and the execution of a complicated procedure. In the present aspect of the present invention, however, such switching may be effected safely and smoothly.

The host mode execution program contains, for instance, an ATA command based file transfer procedure, a file address for transfer, the differentiation between PIO transfer (program I/O transfer) and multiword DMA (multiword direct memory access), a file transfer indication on the display section 57, and the information about a process performed for error handling. In step 209, the contents of a direct file transfer are defined as the contents of the operation mode setup section and host mode execution program. The defined contents of a direct file transfer may be used, for instance, to transfer all user data from the parent magnetic disk drive 73 to the child magnetic disk drive 75, use the PIO transfer method, select the defrag copy mode, and cause the display section 57 to blink red during a file transfer and glow green upon completion of the file transfer.

The defined contents of a direct file transfer may also be used, for instance, to transfer drive information from the child magnetic disk drive 75 to the parent magnetic disk drive 73, use the multiword DMA transfer method, and cause the display section 57 to glow green upon completion of a file transfer. When drive information is selected as a transfer file, the drive information may be copied to the child magnetic disk drive 75. Therefore, even if the child magnetic disk drive 75 is incompatible with the parent magnetic disk drive 73 as they differ, for instance, in manufacturer, firmware version, or capacity, the child magnetic disk drive 75 may be used in the same operating environment as for the parent magnetic disk drive 73.

The following description deals with an example in which user data is transferred from the parent magnetic disk drive 73 to the child magnetic disk drive 75. However, the parent magnetic disk drive 73 may voluntarily operate to accomplish a file transfer even when it involves a different file type or is made in an opposite direction. When, for instance, the files to be transferred comprise firmware for providing the basic operations of the parent magnetic disk drive 73 or child magnetic disk drive 75, the firmware may be copied to the magnetic disk 11 or EEPROM 43 of a magnetic disk drive at a transfer destination. The firmware may be updated to the transferred one the next time the power turns on. This known method may be used to port firmware from one magnetic disk drive to another. When the preparations for a transfer are completed in step 209, the program flow proceeds to step 211. In step 211, the parent magnetic disk drive 73 starts writing user data into the child magnetic disk drive 75.

In the parent magnetic disk drive 73, the MPU 25, which executes the host mode execution program, sends an ATA command for data transfer to the child magnetic disk drive 75, performs a predetermined procedure to start a user data transfer that is written in the program, and causes the display section 57 to blink red. If the dead copy mode is selected as a transfer method to make a copy of the magnetic disk 11, the user data is transferred in the order of physical sector arrangement, that is, in PBA sequence. Even if an alternate sector is furnished as a substitute for a physically defective sector or any unused sector is encountered due to fragmentation, a dead copy is made by copying the user data in such a manner that the magnetic disk 11 of the parent magnetic disk drive 73 is equal to the magnetic disk 11 of the child magnetic disk drive 75 in PBA arrangement. The dead copy is made in compliance with the order of cylinder arrangement and magnetic disk rotation. Therefore, a high-speed data transfer may be made without performing any unnecessary seek operation and without rotational delay.

If the defrag copy mode is selected as a transfer method to make a copy of the magnetic disk 11, data transfer takes place in the logical order of files. If an alternate sector is furnished as a substitute for a defective sector, the data is read from the alternate sector position and transferred as the data at the defective sector position. If there is any fragmented sector, the data is transferred in the logical order of files. In the defrag copy mode, a data transfer is made in the logical order of files. The time required for a data transfer is long because the head 15 of the parent magnetic disk drive 73 repeatedly performs a seek operation and suffers from rotational delay. In the storage state of files written on the magnetic disk 11 of the child magnetic disk drive 75, however, their logical sequence coincides with the physical sequence of sectors. Therefore, when such files are to be read, the access speed may be raised by reducing the seek time and rotational delay.

When the child magnetic disk drive 75 operates as a parent magnetic disk drive with the special jumper block 53 mounted on the child magnetic disk drive 75, which is defrag-copied, and then a dead copy of user data is made in another child magnetic disk drive, defragmented user data may be written at a dead copy speed. When a data transfer is completed in step 213, the MPU 25 of the parent magnetic disk drive 73 causes the display section 57 to glow green and may write user data onto the magnetic disk 11 of the child magnetic disk drive 75 in accordance with the contents of the host mode execution program.

According to the flowchart in FIG. 4, the special jumper block 53 or a combination of the special jumper block 53 and logic gate 45 is used as the operation mode setup section, and the operation mode is determined in step 203 by allowing the MPU 25 to read the contents of the status register, which are set by the special jumper block 53 or the like. In another aspect of the present invention, however, the EEPROM 43 may store event flags without using the special jumper block 53 so that the startup program always reads an event flag concerning the operation mode of the EEPROM 43 within the startup routine. Further, the EEPROM 43 may store in advance host mode execution program parameters such as the transfer data type, transfer method, read/write mode, and PIO transfer/multiword DMA transfer mode, and form a part of the host mode execution program. When an event flag of the EEPROM 43 is used as the operation mode setup section, many parameters may be set up in a more flexible manner than in the use of the jumper block 53 and logic gate 45.

In the present embodiment, the parent and child magnetic disk drives make a pair. Alternatively, however, a plurality of child magnetic disk drives 75 may be connected to a single parent magnetic disk drive 73 via a bus or the like. When such an alternative configuration is employed, the host mode execution program of the parent magnetic disk drive 73 may include a function for choosing from a plurality of child magnetic disk drives.

Description of a Direct File Transfer Between Parent and Child Magnetic Disk Drives in Compliance with Instructions from a Host Computer

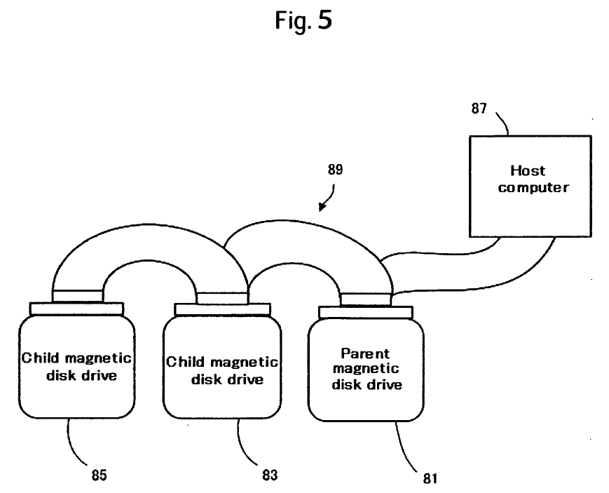

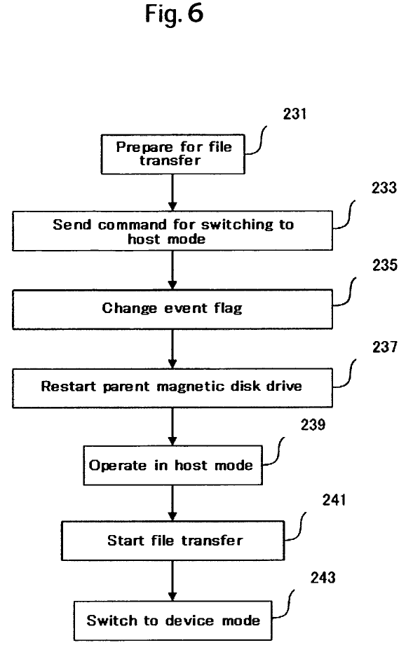

Another embodiment of the present invention will now be described with reference to FIGS. 5 and 6. In the present embodiment, a file transfer is directly made among a plurality of magnetic disk drives 81, 83, 85 that are connected to a host computer 87. In step 231, the preparations for a file transfer are made by connecting the plurality of magnetic disk drives 81, 83, 85 to the host computer 87. Magnetic disk drives 81, 83, and 85 employ virtually the same configuration as magnetic disk drive 10, which is described with reference to FIG. 1, and include the host mode execution program and device mode execution program. Unlike magnetic disk drive 10, however, magnetic disk drives 81, 83, and 85 adopt the SCSI interface method and execute SCSI commands. In the present embodiment, a choice between the host mode and device mode is not made by using the special jumper block 53. It is made in compliance with instructions from the host computer 87. Magnetic disk drives 81, 83, and 85 are daisy-chain connected with SCSI cables 89. Power is supplied to these magnetic disk drives so that they operate in compliance with instructions from the host computer 87.

In step 231, magnetic disk drives 81, 83, and 85 set an event flag in the EEPROM 43 so as to select the device mode and operate in the device mode as a storage device external to the host computer 87. Magnetic disk drives 81, 83, and 85 may operate in the host mode to actively transfer files to the other magnetic disk drives. The following explanation assumes that the host computer 87 selects magnetic disk drive 81 as a parent magnetic disk and magnetic disk drives 83 and 85 as child magnetic disk drives, and that the parent magnetic disk 81 directly transfers files to the child magnetic disk drives 83, 85 via SCSI cables 89.

In step 233, the host computer 87 specifies an SCSI ID to select the parent magnetic disk drive 81, and the parent magnetic disk drive 81 reads the host mode execution program from the ROM 41, loads it into the RAM 39, and transmits a host mode setup command to operate in the host mode. The host mode setup command contains a command for setting the event flag of the EEPROM 43 to the host mode and a command for restarting the magnetic disk drive 81. The host mode setup command is not employed as standard command for the SCSI standard. The host mode setup command may also contain the SCSI ID of child magnetic disk drive 83 or 85 to which the parent magnetic disk drive 81 running in the host mode transfers files. When the host computer 87 sends a command to the parent magnetic disk drive 81 while the above configuration is employed, the parent magnetic disk drive 81 selects child magnetic disk drive 83 or 85 and transfers files to the selected child magnetic disk drive even if the SCSI ID of the magnetic disk drive at the destination is not written in the host mode execution program.

If setup is performed so as to prompt the user to enter a password in a situation where the host computer 87 uses the host mode setup command, it is possible to prevent the user from inadvertently entering the host mode. In magnetic disk drives 81, 83, and 85, the ROM 41 contains a program for receiving and interpreting the host mode setup command in the device mode. However, only magnetic disk drive 81, which is selected as a parent magnetic disk drive by the host computer 87, is allowed to interpret the host mode setup command and operate in the host mode as described below.

When the parent magnetic disk drive 81 interprets the host mode setup command, the MPU 25 changes the event flag of the EEPROM 43 to switch from the device mode to the host mode (step 235). Next, magnetic disk drive 81 turns off and the restarts (step 237). When magnetic disk drive 81 restarts, the startup program causes the MPU 25 to reference the event flag of the EEPROM 43, read the host mode execution program from the ROM 41 or magnetic disk 11, load the read program into the RAM 39, and execute the host mode execution program. Magnetic disk drive 81 then operates in the host mode (step 239). Alternatively, the host mode setup command may be without a restart command so that the MPU 25 executes a command for setting the event flag of the EEPROM 43 to the host mode and then prompts the user to restart magnetic disk drive 81. An alternative for step 237 is to turn off only the MPU 25 without shutting off the entire power supply to magnetic disk drive 81, and turn the MPU 25 back on to allow the MPU 25 to load the host mode execution program into the RAM 39.

After entering the host mode, the parent magnetic disk drive 81 performs step 241 to transfer files to child magnetic disk drive 83 or 85 by using an SCSI command in compliance with the host mode execution program. If the SCSI ID of the magnetic disk drive at the destination is written in the EEPROM 43, the child magnetic disk drive to which the files are to be transferred may be determined by referencing the SCSI ID when the parent magnetic disk drive 81 restarts. The contents of the transfer file and the transfer method are the same as described with reference to FIGS. 3 and 4. To prevent a write command from being generated to write the files into a child magnetic disk drive while the parent magnetic disk drive is transferring the files to the child magnetic disk drive, the I/O port is placed in the input mode or in a high-impedance state as a precautionary measure.

Upon termination of a file transfer, the program flow proceeds to step 243. In step 243, the parent magnetic disk drive 81 sends a transfer termination command to the host computer 87, and the host computer 87 sends a device mode setup command to the parent magnetic disk drive 81 to place the parent magnetic disk drive 81 back in the device mode. The device mode setup command for returning to the device mode contains a command for changing the event flag of the EEPROM 43 to switch from the host mode to the device mode and a command for restarting the parent magnetic disk drive 81. When a magnetic disk drive is to be replaced in a situation where a plurality of magnetic disk drives are handled by the host computer, the use of the above file transfer method makes it possible to copy files from an old magnetic disk drive to a new magnetic disk drive without using the processor or memory of the host computer. Therefore, the file transfer method described above provides increased convenience.

The present embodiment has been described on the assumption that three magnetic disk drives are used. According to the SCSI-3 standard, however, up to 32 magnetic disk drives may be daisy-chain connected with SCSI cables. Therefore, even when four or more magnetic disk drives are connected, it is possible to operate one of them in the host mode as a parent magnetic disk drive and transfer files to an arbitrarily selected child magnetic disk drive from the parent magnetic disk drive. Further, it is possible to operate the child magnetic disk drive, to which the files have been transferred, in the host mode as a parent magnetic disk drive, and transfer the files to another daisy-chained child magnetic disk drive in the same manner as above. The configuration in which child magnetic disk drives to which files have been transferred sequentially serve as a parent magnetic disk drive and as a file transfer source is effective for a situation where a defrag copy is to be made as described earlier.

The SCSI IDs of daisy-chained devices are to be uniquely determined. The use of such SCSI IDs provides increased convenience because no SCSI ID change is required for a newly connected child magnetic disk drive in a situation where the parent magnetic disk drive 81 sequentially transfers files to a plurality of child magnetic disk drives. Even if, in the above example, the parent magnetic disk drive 81 first transfers files to child magnetic disk drive 83, then transfers files to child magnetic disk drive 85, and child magnetic disk drive 83 is changed to new child magnetic disk drive 87 (not shown) during the file transfer to child magnetic disk drive 85, the SCSI ID of child magnetic disk drive 83 may be used for child magnetic disk drive 87. Therefore, the parent magnetic disk drive 81 may transfer files sequentially to each newly connected magnetic disk drive by using the SCSI IDs of child magnetic disk drives 83 and 85. The SCSI ID of each child magnetic disk drive may be set with a jumper block or DIP switch.

Description of Cloning Through a Direct File Transfer Between Magnetic Disk Drives

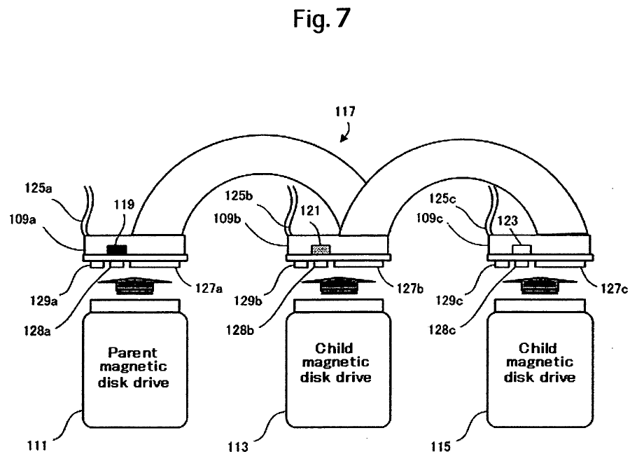

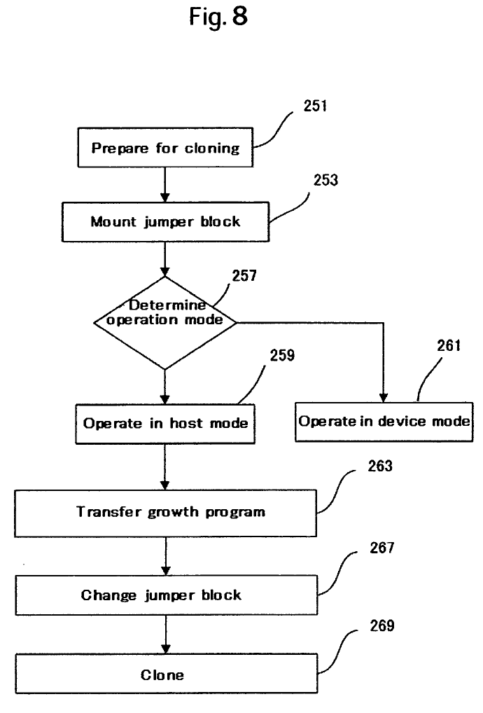

The technique for making a direct file transfer between parent and child magnetic disk drives has been described with reference to FIGS. 3 through 6. An embodiment for porting a program for performing an optimization/inspection process on a child magnetic disk drive by using the above technique and allowing a parent magnetic disk drive to grow the child magnetic disk drive as a clone will now be described with reference to FIGS. 7 and 8. FIG. 7 illustrates a connection scheme for generating a clone device by making a direct file transfer between magnetic disk drives. FIG. 8 is a flowchart illustrating a cloning procedure. For explanation purposes, the present embodiment assumes that magnetic disk drive 111 is a parent magnetic disk drive and that magnetic disk drives 113 and 115 are child magnetic disk drives.

Step 251 is performed to prepare for cloning. As indicated in FIG. 7, three magnetic disk drives 111, 113, 115 are prepared. These magnetic disk drives adopt the ATA interface method and are configured virtually the same as the magnetic disk drive 10 that is described with reference to FIG. 1. One difference is that the magnetic disk 11 of magnetic disk drive 111 stores an optimization/inspection program, which will be described later. Another difference is that the EEPROM 43 stores knowhow. Further, the host mode execution programs for magnetic disk drives 111, 113, and 115 include a function for handling the optimization/inspection program and knowhow.

Three connection devices 109a, 109b, 109c are furnished for magnetic disk drives 111, 113, and 115. The connection devices include interface connectors 127a, 127b, 127c, jumper connectors 128a, 128b, 128c, power supply connectors 129a, 129b, 129c, and power cables 125a, 125b, 125c, which are connected to the power supply connectors. An ATA cable 117 is used to make a connection between interface connectors 127a and 127b and between interface connectors 127b and 127c.

Parent magnetic disk drive 111 is a magnetic disk drive for which the above-mentioned optimization/inspection process has already been performed. Child magnetic disk drives 113 and 115 are magnetic disk drives that are assembled completely and grown enough to communicate with the parent magnetic disk drive. However, child magnetic disk drives 113 and 115 need to go through the optimization/inspection process before they are finished. The EEPROM 43 of parent magnetic disk drive 111 stores various parameters that were acquired when parent magnetic disk drive 111 executed the optimization/inspection program, which was stored on the magnetic disk 11, to perform its own optimization/inspection process. According to the present embodiment, the various parameters stored in the EEPROM 43 constitute the knowhow of a magnetic disk drive and may be inherited by the child magnetic disk drives.

Within this specification, a combination of the knowhow or parameters stored in the EEPROM 43 and the optimization/inspection program stored on the magnetic disk 11 is referred to as a growth program. The term “cloning” means to port the growth program from a parent magnetic disk drive to a child magnetic disk drive, and allow the child magnetic disk drive to execute the growth program and grow as a magnetic disk drive having the same characteristics as the parent magnetic disk drive.

In step 253, jumper blocks 119, 121, and 123 are mounted on jumper connectors 128a, 128b, and 128c, and magnetic disk drives 111, 113, and 115 are connected to the connection devices. Since jumper block 119 is a special jumper block, magnetic disk drive 111 operates in the host mode upon power on. Jumper blocks 121 and 123 are general-purpose jumper blocks. Therefore, magnetic disk drives 113 and 115 operate in the device mode upon power on. Jumper block 121 is configured to set magnetic disk drive 113 as a master (Dev 0). Jumper block 123 is configured to set magnetic disk drive 115 as a slave (Dev 1). When the ATA standard is complied with, the master and slave are generally set to identify two magnetic disk drives that are connected to the host computer. Instead of using the special jumper block 119 and general-purpose jumper blocks 121, 123, logic formation may be accomplished by connecting jumper connectors 128a, 128b, and 128c to a control circuit that is capable of performing logic state setup.

In step 257, magnetic disk drives 111, 113, and 115 are turned on for startup. Magnetic disk drive 111 starts running in the host mode and functions as a parent magnetic disk drive (step 259). Magnetic disk drives 113 and 115 start running in the device mode and function as child magnetic disk drives (step 261). In step 263, the parent magnetic disk drive 111, in which the host mode execution program is running, starts transferring the growth program to perform a sequential cloning process for child magnetic disk drive 113 or 115. The parent magnetic disk drive 111 specifies the address of either of the two child magnetic disk drives, transfers the growth program with an ATA command, and writes the growth program into the EEPROM 43 of a child magnetic disk drive or onto the magnetic disk 11. Upon termination of the transfer, the parent magnetic disk drive 111 transfers the growth program to the remaining child magnetic disk drive in the same manner as described above.

After the growth program has been transferred to the two child magnetic disk drives 113, 115, step 267 is performed to replace the jumper blocks of connection devices 109b and 109c with the special jumper blocks for host mode operations. The special jumper blocks cause the child magnetic disk drives 113, 115 to operate in the host mode and the host mode execution program to execute the growth program. In step 269, the child magnetic disk drives 113, 115 execute the growth program, which has been ported by the parent magnetic disk drive 111, to perform their own optimization/inspection process, and inherit the knowhow of the parent magnetic disk drive 111 to become a finished magnetic disk drive. The child magnetic disk drives 113, 115, which are now grown, may become a parent magnetic disk drive to perform the cloning process in the same manner as described above for the other child magnetic disk drives.

Description of the Optimization/Inspection Process Performed Between Magnetic Disk Drives

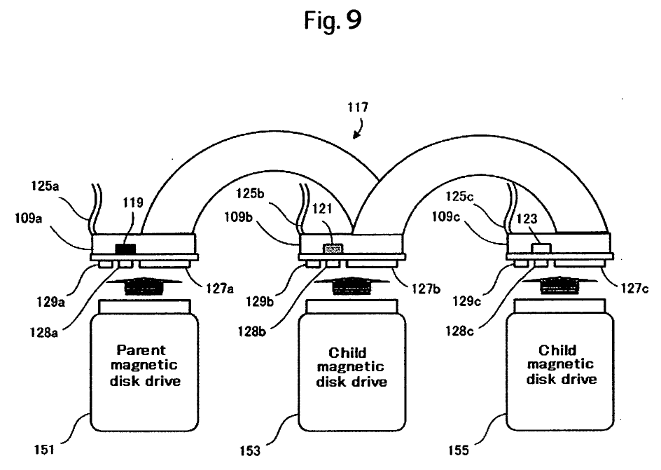

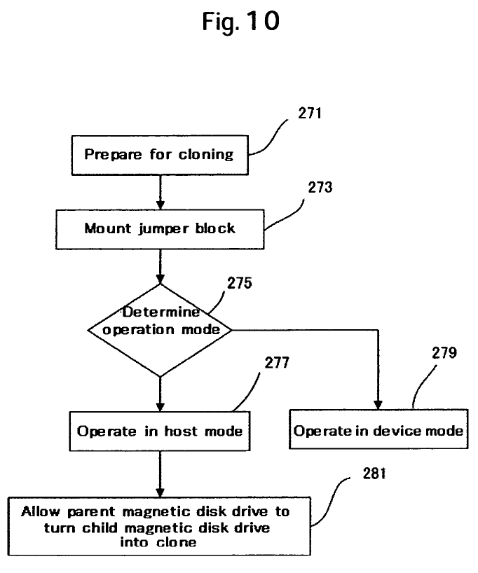

The method for porting the growth program from a parent magnetic disk drive to child magnetic disk drives and allowing the child magnetic disk drives to execute the growth program has been described with reference to FIGS. 7 and 8. Another embodiment, which provides a method for allowing a parent magnetic disk drive to grow a child magnetic disk drive while communicating with the child magnetic disk drive, will now be described with reference to FIGS. 9 and 10. FIG. 9 illustrates a connection scheme for allowing a parent magnetic disk drive to grow a child magnetic disk drive while communicating with the child magnetic disk drive. FIG. 10 is a flowchart illustrating a cloning procedure. For explanation purposes, the present embodiment assumes that magnetic disk drive 151 is a parent magnetic disk drive and that magnetic disk drives 153 and 155 are child magnetic disk drives.

Step 271 is performed to prepare for cloning. FIG. 9 differs from FIG. 7 in the internal configurations of the three magnetic disk drives 151, 153, 155. The other elements will not be described herein because they are the same as with the previous embodiment. Magnetic disk drives 151, 153, and 155 are configured virtually the same as magnetic disk drive 10, which is described with reference to FIG. 1. These magnetic disk drives adopt the ATA interface method, and differ from magnetic disk drive 10 in that the magnetic disk 11 of magnetic disk drive 151 stores an education program, which will be described later, and that magnetic disk drives 151, 153, and 155 may handle the education program as a parent or child magnetic disk drive.

The magnetic disk 11 of the parent magnetic disk drive 151 stores an education program for performing an optimization/inspection process on a child magnetic disk drive while communicating with the child magnetic disk drive. The education program is used, for instance, to write servo information into a child magnetic disk drive, conduct a preliminary inspection for optimizing various servo coefficients and channel coefficients, perform a function/reliability verification test, which is basically a long-run test, and perform defective sector mapping.

The parent magnetic disk drive 151 is a magnetic disk drive for which the above-mentioned optimization/inspection process has already been performed. The child magnetic disk drives 153, 155 are magnetic disk drives that are assembled completely and grown enough to communicate with the parent magnetic disk drive to receive education. However, the child magnetic disk drives 153, 155 need to go through the optimization/inspection process before they are finished. The EEPROM 43 of the parent magnetic disk drive 151 stores various parameters that were acquired when the parent magnetic disk drive 151 performed its own optimization/inspection process. The stored parameters are used as knowhow.

Steps 273 through 279 are identical with steps 253 through 261. The parent magnetic disk drive 151 starts operating in the host mode. The child magnetic disk drives 153, 155 start operating in the device mode. In step 281, the parent magnetic disk drive 151 in which the host mode execution program is running executes the education program to start an operation for educating a child magnetic disk drive for cloning purposes. The parent magnetic disk drive 151 specifies the address of either of the two child magnetic disk drives, transfers firmware or writes servo information with an ATA command, and performs an optimization/inspection process on the child magnetic disk drive. In this instance, the knowhow stored in the EEPROM 43 of the parent magnetic disk drive is also ported to the child magnetic disk drive. The education sequence ends when the optimization/inspection process is sequentially performed on the two child magnetic disk drives 153, 155 to grow them. Formerly, an education program was executed for a child magnetic disk drive with a magnetic disk drive connected to an inspection device. However, the present embodiment may operate the parent magnetic disk drive 151 as an inspection device without having to use any external inspection device. The amount of investment into an inspection device may therefore be reduced. In addition, an educated child magnetic disk drive may be operated as a parent magnetic disk drive to educate another child magnetic disk drive.

In the foregoing examples, the magnetic disk drives have been described as storage devices. However, the present invention may also be applied to a magneto-optical disk drive, floppy disk drive, CD drive, DVD drive, PD drive, and various other processor-based external storage devices or auxiliary storage devices. In the foregoing examples, the file transfer between a parent magnetic disk drive and child magnetic disk drive or between a parent magnetic disk drive and host computer has been made via a hard-wire connection. Alternatively, however, the file transfer may be made wirelessly. Further, an ATA, serial ATA, SCSI, or Fibre Channel data transmission path may be used for a data transfer between magnetic disk drives.

FIGS. 5 and 6 illustrate a situation where the file transfer between parent and child magnetic disk drives is made via an SCSI interface in compliance with instructions from the host computer. However, a method for making a file transfer between magnetic disk drives that are connected via a Fibre Channel interface will now be described. First of all, a case where eight magnetic disk drives are daisy-chain connected via an SCSI interface and a parent magnetic disk drive, which is designated as magnetic disk drive No. 1, sequentially transfers files to the remaining seven child magnetic disk drives, which are designated as magnetic disk drives No. 2 through No. 8, will be considered.

It is assumed that the code written in the host mode execution program of the parent magnetic disk drive sequentially transfers files to child magnetic disk drives No. 2 through No. 8 in order named. When the host computer first operates the parent magnetic disk drive (magnetic disk drive No. 1) in the host mode, the parent magnetic disk drive sequentially transfers files to child magnetic disk drives No. 2 through No. 8 in order named. Therefore, when files are to be transferred to all the seven child magnetic disk drives, the parent magnetic disk drive (magnetic disk drive No. 1) and child magnetic disk drives No. 2 through No. 8 sequentially make a file transfer while performing a bus connection procedure. It means that the time required for file transfer completion is the time required for making seven file transfers.

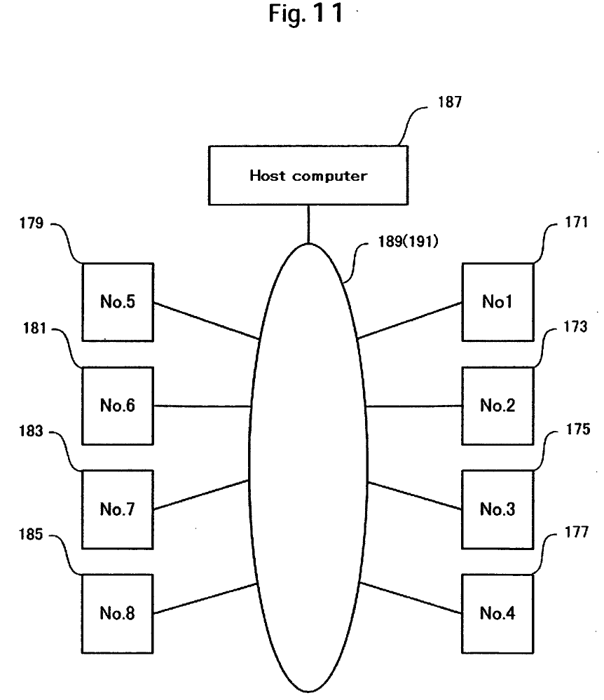

FIG. 11 shows an example in which a host computer 187 is connected to magnetic disk drives 171 through 185 via a Fibre Channel arbitrated loop 189 so that data may be transferred in accordance with a Fibre Channel communications protocol. It is assumed that magnetic disk drive No. 1 (171) is a parent magnetic disk drive, which has files to be transferred, and that magnetic disk drives No. 2 through No. 8 (173 through 185) are child magnetic disk drives, which receive the files. The parent magnetic disk drive 171 and child magnetic disk drives 173 through 185 have a host mode execution program for executing a procedure explained later and an interface for the arbitrated loop 189, are configured the same as the magnetic disk drive 10 shown in FIG. 1, and operate in the host mode or device mode. The host computer 187 asks the child magnetic disk drives 173 through 185 beforehand about their WWNs (World Wide Names) and notifies the parent magnetic disk drive 171 of them. It is assumed that magnetic disk drives 171 through 185 initially operate in the device mode. The host computer 187 sends a host mode setup command to the parent magnetic disk drive 171. The host mode setup command contains a command for setting the event flag of the EEPROM to the host mode and a command for restarting the parent magnetic disk drive 171.

Next, the parent magnetic disk drive 171 restarts and operates in the host mode. The procedure for causing the parent magnetic disk drive 171 to transfer files to the child magnetic disk drives 173 through 185 is written in the host mode execution program that is stored in the ROM. The parent magnetic disk drive 171 reads data n1, which is a part of a file to be transferred, from a magnetic disk, stores data n1 in a cache, attaches the identifier of magnetic disk drive 173 to data n1, and transmits data n1 to the arbitrated loop 189. The transmitted data n1 enters the arbitrated loop 189 and passes through the child magnetic disk drives 173 through 185. However, data n1 is read only by child magnetic disk drive 173, whose identifier agrees with the identifier attached to data n1, and written at a specified address on the local magnetic disk.

Next, the parent magnetic disk drive 171 acquires data n1 from the cache, attaches the identifier of child magnetic disk drive 175 to data n1, and sends data n1 to the arbitrated loop 189. Then, data n1 is read only by child magnetic disk drive 175, whose identifier agrees with the identifier attached to data n1, and written at a specified address on the local magnetic disk. When data n1 is similarly written onto the magnetic disks of child magnetic disk drives 177 through 185, the parent magnetic disk drive 171 reads data n2, which follows data n1, from the local magnetic disk, stores data n2 in the cache, attaches the identifier of child magnetic disk drive 173 to data n2, and sends data n2 to the arbitrated loop 189. Then, only child magnetic disk drive 173, whose identifier agrees with the identifier attached to data n2, writes data n2 at a specified address of the local magnetic disk.

The parent magnetic disk drive 171 acquires data n2 from the cache, attaches the identifier of child magnetic disk drive 175 to data n2, and sends data n2 to the arbitrated loop 189. When this procedure is repeatedly performed, the parent magnetic disk drive 171 divides necessary files into data n1, data n2, data n3, and so on, and transfers them to child magnetic disk drives 173 through 185. When Fibre Channel is used, a high data transfer speed may be achieved because it is not necessary to perform any bus connection procedure. The amount of data to be transferred at a time to Fibre Channel by the parent magnetic disk drive, such as data n1 and data n2, may be specified by selecting a sector unit, a cluster unit, a unit permitted by the cache of the parent magnetic disk drive, or a unit prescribed by the Fibre Channel communications protocol. When child magnetic disk drives 173 through 185, for which the file transfer has been made, are changed to new child magnetic disk drives, the host computer 187 asks the new child magnetic disk drives about their WWNs and notifies the parent magnetic disk drive 171 of them. When this method is employed, a fabric switch, which will be described next, may be used as a substitute for the arbitrated loop 189.

In another file transfer method, a child magnetic disk drive to which files have been transferred from the parent magnetic disk drive operates as a parent magnetic disk drive and transfers files to the other child magnetic disk drives together with the original parent magnetic disk drive. When this method is used, the arbitrated loop 189 shown in FIG. 11 is replaced by a fabric switch 191 so that the host computer 187 and magnetic disk drives 171 through 185 transfer data in compliance with a communications protocol that conforms to the fabric switch. The system for making such a data transfer is disclosed, for instance, by Japanese Patent Laid-Open Nos. 2002-342253 and 2000-222339. The system using the fabric switch, which is shown in FIG. 11, may establish multiplex communication by forming a plurality of data transfer device pairs.

When the above method is used, the magnetic disk drive 171 initially operates in the host mode to serve as a parent magnetic disk drive and transfers files to the child magnetic disk drive 173. Next, the child magnetic disk drive 173 becomes a parent magnetic disk drive and transfers files together with the parent magnetic disk drive 171. More specifically, a data transfer device pair is formed for allowing the parent magnetic disk drive 171 to transfer files to the child magnetic disk drive 175 and the parent magnetic disk drive 173 to transfer files to the child magnetic disk drive 177.

Next, child magnetic disk drives 175 and 177 operate in the host mode to serve as parent magnetic disk drives. These parent magnetic disk drives cooperate with parent magnetic disk drives 171 and 173 (a total of four magnetic disk drives) to respectively make a pair with the remaining four magnetic disk drives 179 through 185 and transfer files to magnetic disk drives 179 through 185. For example, the parent magnetic disk drive 171 transfers files to the child magnetic disk drive 179; the parent magnetic disk drive 173 transfers files to the child magnetic disk drive 181; the parent magnetic disk drive 175 transfers files to the child magnetic disk drive 183; and the parent magnetic disk drive 177 transfers files to the child magnetic disk drive 185.

When the above method is used, the parent and child magnetic disk drives may simultaneously make a plurality of file transfer device pairs and the fabric switch makes it possible to transfer files in a time-sharing manner. For example, the magnetic disk drive 173 may start transferring files to the magnetic disk drive 177 before the magnetic disk drive 171 completes its file transfer to the magnetic disk drive 175. In this manner, the time required for transferring files to all magnetic disk drives may be considerably reduced.

When the operation mode is to be changed to let a child magnetic disk drive operate as a parent magnetic disk drive, it is necessary that the host computer 187 restart the child magnetic disk drive by sending a restart command to it. When compared to the original parent magnetic disk drive, which changes the file transfer destination magnetic disk drive while running in the host mode, the above child magnetic disk drive starts transferring files with a delay because it has to go through a restart process. However, when a large amount of data is to be transferred for file transfer purposes, the time required for file transfer is longer than the time required for a restart. Therefore, the use of the above method achieves a file transfer rapidly.

Description of an ATA Magnetic Disk Drive Test Controller and the Like

The following description deals with a method for performing a local test/adjustment process without being limited by the size and characteristics of the test/adjustment program that was proposed by the previous patent application, and a local test/adjustment method and test controller for use with a magnetic disk drive having an ATA interface.

Meaning of the Test/Adjustment Process

Within this specification, the term “test/adjustment process” has the same meaning as the optimization/inspection process. The test/adjustment process is performed to impart finished product functions to a completely assembled magnetic disk drive and incorporate functions into hardware so as to give a guarantee to the user. One example of a test/adjustment is to write servo information onto a magnetic disk. This servo information write is performed in a magnetic disk drive that employs a self servo write method. When the self servo write method is adopted, a head incorporated in the magnetic disk drive writes servo information onto a local magnetic disk without using a servo track writer or other dedicated writer.

Another example of a test/adjustment is to inspect a magnetic disk and register defective sectors. In general, finished magnetic disks may have defects in a magnetic layer. Even when a small defect is allowed to exist, it may expand. To assure the quality of a magnetic disk drive, it may be necessary to inspect all sectors in advance and register the logical address of any defective sector in a primary defect map (PDM) to make the defective sector unavailable.

Still another example of a test/adjustment is to register track position information. When a magnetoresistive (MR) read head or giant magnetoresistive (GMR) read head is employed, an inductive write head is mounted on a slider and positioned at a fixed distance from the read head. Dimensional tolerance is defined on a spacing interval between the write head and read head. If a rotary actuator is used, the slider turns on the rotation shaft of the actuator. Therefore, a yaw angle arises depending on the head position in the radial direction of the magnetic disk. The yaw angle may change the positional relationship between a track to which the write head corresponds and a track to which the read head corresponds.

More specifically, the yaw angle varies with the position of the slider over the magnetic disk. Therefore, the spacing interval between a track over which the read head is positioned and a track over which the write head is positioned also varies. To recognize the distance between a track position at which the read head is positioned and a track position at which data is actually written and properly read, the magnetic disk drive needs to write servo information onto the magnetic disk, acquire track position information specific to the head, and properly recognize the positional relationship between the read and write heads at all positions on the magnetic disk.

Tolerance is also defined on the width and sensitivity of the read head. Therefore, the test/adjustment process is required for making it possible to detect accurate track position information from servo information by adjusting the PES (position information signal) gain of an amplifier for amplifying a position information signal (PES), which is reproduced after reading a servo burst pattern from the servo information, in accordance with the manufacturing properties of the read head.

For the above test/adjustment process, it is necessary, for instance, to actually move the heads to specified positions over the magnetic disk or write a logical sector address into the EEPROM Of the magnetic disk drive. When a dedicated tester is used to perform the test/adjustment process, it controls each operation of the magnetic disk drive by sending a command to the magnetic disk drive while monitoring the responses from the magnetic disk drive.

For the test/adjustment process according to the present invention, no dedicated tester is used to directly control the operation of a target magnetic disk drive. The test/adjustment program is transferred from an external host apparatus to the magnetic disk drive so that the magnetic disk drive locally executes the test/adjustment program to perform a local test/adjustment process. Some parts of the test/adjustment program cause an external host apparatus to send a command to and monitor the response from the target magnetic disk drive. However, the test/adjustment program does not cause the host apparatus to directly control the head operations of the magnetic disk drive unlike the dedicated tester.

Basic Test/Adjustment Method

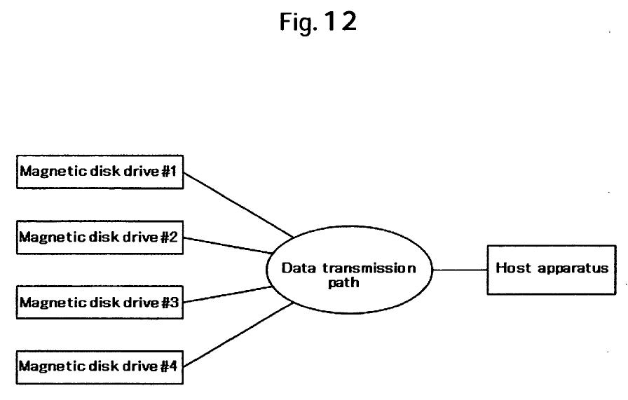

FIG. 12 illustrates a basic execution environment for performing a local test/adjustment process on a magnetic disk drive in accordance with one embodiment of the present invention. As shown in FIG. 12, a host apparatus is connected to magnetic disk drives #1 through #4, which are to be subjected to a local test/adjustment process, via a data transmission path so that data may be transferred between the host apparatus and magnetic disk drives #1 through #4. Magnetic disk drives #1 through #4 do not have product functions yet because they have not gone through a test/adjustment process although they have gone through a hardware assembly process. However, the firmware for performing basic operations is stored in a ROM so that the system for communicating with external devices, the MPU, the RAM, and other components requiring no special test/adjustment are already operative.

The host apparatus is a computer that is capable of establishing data communication with magnetic disk drives #1 through #4 via the data transmission path. Further, the host apparatus includes, for instance, a processor, a RAM, a ROM, an auxiliary storage device, and an interface circuit for magnetic disk drives #1 through #4. The auxiliary storage device included in the host apparatus stores a test/adjustment program, which is to be executed by magnetic disk drives #1 through #4. The test/adjustment program is transferred from the host apparatus to magnetic disk drives #1 through #4 via the data transmission path.

The test/adjustment program is divided into a plurality of phases. They are transferred to magnetic disk drives #1 through #4 in a predetermined order. The present embodiment assumes that the test/adjustment program comprises five phases: first to fifth phases. In the example described herein, magnetic disk drives #1 through #4 execute the first to fourth phases of the test/adjustment program, and the host apparatus executes the fifth phase of the test/adjustment program.

It is assumed that the first, second, third, and fourth phases of the test/adjustment program relate to a servo information write onto a magnetic disk, defective sector detection and registration, track information collection and write, and PES gain adjustment, respectively.

The first to fourth phases of the test/adjustment program are transferred from the host apparatus to each magnetic disk drive in the order of the phase numbers. The fifth phase of the test/adjustment program is a command test concerning possible user operations. In the fifth phase, the host apparatus executes the program. When executed, the fifth phase of the program sends a read/write command to each magnetic disk drive to check for an improper response or sends a reset command or diagnostic command to check the results. The fifth phase of the test/adjustment program will not transferred to each magnetic disk drive.

The auxiliary storage device in the host apparatus stores a test control program, which sequentially transfers the first to fourth phases of the test/adjustment program to each magnetic disk drive for execution and executes the fifth phase of the test/adjustment program. Magnetic disk drives #1 through #4 are general-purpose magnetic disk drives that are to be sold to the user. However, they store in their ROM a test program for executing the test/adjustment program transferred from the host apparatus. The data transmission path should conform to a protocol for establishing communication between the host apparatus and magnetic disk drives #1 through #4. Consequently, the data transmission path may comprise an ATA (AT Attachment) bus, SCSI bus, Fibre Channel, or the like. When Fibre Channel is used, the arbitrated loop or fabric switch may be employed.

The present embodiment is characterized by the fact that the test/adjustment program is divided into a plurality of phases. The reasons for dividing the test/adjustment program into a plurality of phases will now be described. Firstly, magnetic disk drives #1 through #4, which are targeted for the test/adjustment process, have not gone through the test/adjustment process. Therefore, they cannot operate their heads to write a program onto a magnetic disk or read a program from a magnetic disk. Consequently, they cannot use their magnetic disk as a place for storing the test/adjustment program that is transferred from the host apparatus.

As such being the case, the size of the test/adjustment program that each magnetic disk drive may receive from the host apparatus is limited by the capacity of the RAM. Therefore, the test/adjustment program may be executed by each magnetic disk drive when the host apparatus divides the test/adjustment program into appropriate segments that may be temporarily stored in the RAM of each magnetic disk drive and executed by the CPU.

Secondly, the first to fourth phases of the test/adjustment program are locally executed within each magnetic disk drive. Thus, the first to fourth phases of the test/adjustment program are not adequate for inspecting an interface system that allows each magnetic disk drive to communicate with an external device. Consequently, a command test needs to be performed in the above-mentioned fifth phase of the test/adjustment program.

The test/adjustment process to be performed in the first to fourth phases of the test/adjustment program is locally executed by each magnetic disk drive and not governed by the host apparatus. However, the command test in the fifth phase of the test/adjustment program is conducted while the host apparatus communicates with each magnetic disk drive. The fifth phase of the test/adjustment program needs to be separated from the first to fourth phases of the test/adjustment program because they are executed by different apparatuses. Even when the first to fourth phases of the test/adjustment program do not need to be divided for transfer due, for instance, to an increased RAM capacity, the fifth phase of the test/adjustment program needs to be separated from the first to fourth phases of the test/adjustment program.

A plurality of technicians in various specialized fields are involved in the test/adjustment process. When the test/adjustment program is divided into individual specialized fields, increased convenience may be provided for program production and test result evaluation. In the test/adjustment process, magnetic disk drives in which defective parts are incorporated may be urgently screened and barred from being shipped. In this instance, an independent screening program should be created and transferred from the host apparatus to each magnetic disk drive as an independent phase (e.g., phase 2-1) of the test/adjustment program for the sake of simplicity rather than incorporating the screening program into the first, second, third, or fourth phase of the test/adjustment program. If no more screening is required, only the screening program may be deleted from the test/adjustment program. When the test/adjustment process is to be locally performed in an environment shown in FIG. 1, it is necessary to divide the test/adjustment program for transfer and separate the command test from the other tests that are performed within a magnetic disk drive only.

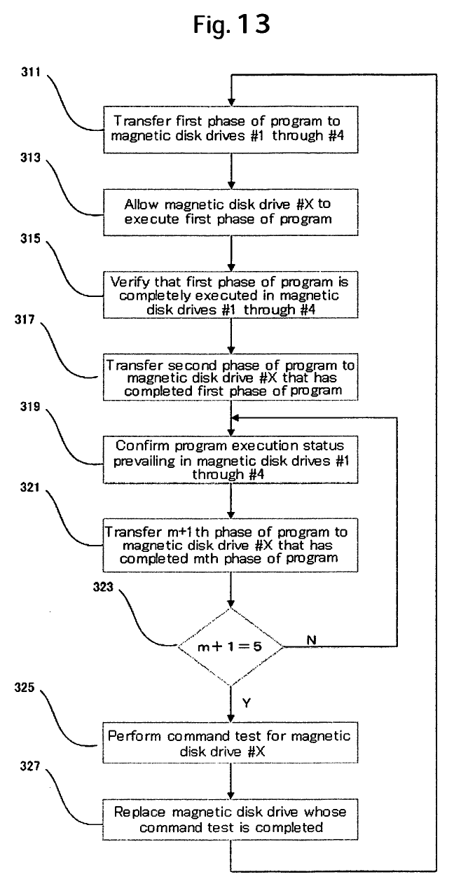

The method for testing/adjusting magnetic disk drives #1 through #4 in an environment shown in FIG. 12 will now be described with reference to FIG. 13. FIG. 13 is a flowchart illustrating a basic test/adjustment procedure that is to be locally performed. It is assumed herein that no test/adjustment is performed for magnetic disk drives #1 through #4. In step 311, the host apparatus transfers the first phase of the test/adjustment program to magnetic disk drives #1 through #4.

In step 313, magnetic disk drive #X (magnetic disk drive #X is a magnetic disk drive between #1 and #4), which has received the first phase of the test/adjustment program, stores the received test/adjustment program in its RAM and executes it. The test program written in the ROM of each magnetic disk drive stores the test/adjustment program in the RAM and causes the CPU to execute it. Magnetic disk drive #X executes the first phase of the test/adjustment program to write servo information onto the local magnetic disk. The program for controlling the contents of the servo information to be written and the head position is contained in the first phase of the test/adjustment program. To start executing the test/adjustment program, the host apparatus may alternatively send an execution start command to a magnetic disk drive after transferring the first phase of the test/adjustment program. As another alternative, the test program stored in the ROM of each magnetic disk drive may automatically recognize and execute various phases of the test/adjustment program when they are sent.

In step 315, the host apparatus detects that the first phase of the test/adjustment program is completely executed in magnetic disk drive #X or detects that the next phase of the test/adjustment program is requested by magnetic disk drive #X. The host apparatus does not send a new command or the second phase of the test/adjustment program while the first phase of the test/adjustment program is being executed in magnetic disk drive #X. This also holds true for the second, third, and fourth phases of the test/adjustment program, which are to be subsequently transferred.

To permit the host apparatus to detect that the next phase of the test/adjustment program is requested by magnetic disk drives #1 through #4, magnetic disk drive #X sends a completion command to the host apparatus. An alternative is to let magnetic disk drive #X set a completion in its register and allow the host apparatus to reference the register. These operations are performed by the test program that is stored in the ROM of each magnetic disk drive.

After the first phase of the test/adjustment program is completely executed, magnetic disk drive #X erases it from the RAM and becomes ready to receive the next phase (second phase) of the test/adjustment program. This operation is also performed after the second, third, or fourth phase of the test/adjustment program is completely executed. In step 317, the host apparatus sends the second phase of the test/adjustment apparatus to magnetic disk drive #X, which has completely executed the first phase of the test/adjustment program.

After receiving the second phase of the test/adjustment program and storing it in the RAM, magnetic disk drive #X starts executing it in the same manner as in step 313. In step 319, the host apparatus confirms the test/adjustment program execution status prevailing in magnetic disk drives #1 through #4. More specifically, the host apparatus recognizes what phase of the test/adjustment program is completed by each magnetic disk drive or recognizes the phase number of the test/adjustment program to be transferred next.

The host apparatus recognizes the phase number of the test/adjustment program that has been completed by magnetic disk drive #X, and calculates the phase to be transferred next. Or, magnetic disk drive #X directly writes the phase number to be requested next into a register and then the host apparatus recognizes the written phase number to determine the phase number of the test/adjustment program to be transferred next. This operation is performed by the test control program of the host apparatus. In step 321, the host apparatus detects what magnetic disk drives (magnetic disk drives #1 through #4) have completed the mth phase of the test/adjustment program, or detects magnetic disk drives that have completed the mth phase of the test/adjustment program and requested the m+1th phase of the test/adjustment program, and transfers the m+1th phase of the test/adjustment program to magnetic disk drive #X.

Step 323 is performed to check whether the phase number of the test/adjustment program to be executed next in magnetic disk drives #1 through #4 is 5. Phase 5 is the last phase of the test/adjustment program. If m+1<5, steps 319 through 323 are repeated so that the host apparatus transfers various phases of the test/adjustment program to magnetic disk drives #1 through #4 in the order of their phase numbers until each magnetic disk drive requests the fifth phase of the test/adjustment program.

If it is found in step 323 that the number of the next phase to be executed by magnetic disk drive #X, which is m+1, is 5, the program flow proceeds to step 325. In step 325, the host apparatus performs a command test, which is in the fifth phase, for magnetic disk drive #X. Step 327 is then performed to remove magnetic disk drive #X, which has gone through the command test, from the data transmission path, connect a new magnetic disk drive, and perform the same test/adjustment procedure. In accordance with a phase number requested by the new magnetic disk drive, various phases of the test/adjustment program are sequentially transferred to the new magnetic disk drive.

Test Controller with an ATA Interface

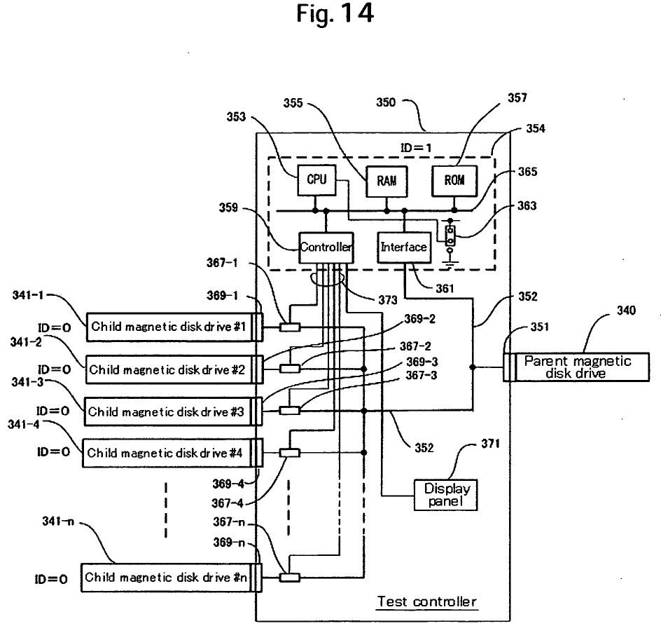

The test controller 350 for performing the test/adjustment process, which has been described with reference to FIGS. 12 and 13, on an ATA magnetic disk drive will now be described with reference to FIG. 14. In FIG. 14, the test controller 350 constitutes the data transmission path shown in FIG. 12, and n child magnetic disk drives 341-1 through 341-n (hereinafter referred to as child magnetic disk drives #1 through #n), which are to be tested/adjusted, are connected to a parent magnetic disk drive 340, which serves as a host apparatus, to establish a test/adjustment program execution environment.

According to the ATA standard, only two magnetic disk drives (master and slave) may be connected to a single host controller. When the child magnetic disk drives to be tested/adjusted are to be directly connected to the parent magnetic disk drive 340, up to two child magnetic disk drives may be connected. In this instance, the parent magnetic disk drive cannot be used as a host apparatus for testing/adjusting a large number of magnetic disk drives within a short period of time. While two magnetic disk drives are being tested/adjusted, one magnetic disk drive cannot be shipped. It means that the production volume decreases. In the present embodiment, however, n (the value n may be greater than 2) child magnetic disk drives (#1 through #n), which employ the ATA interface for the test controller 350, may be connected at a time. Therefore, while one parent magnetic disk drive 340 is used for test/adjustment purposes, n child magnetic disk drives may be tested/adjusted.

The parent magnetic disk drive 340 is a finished product that has gone through the test/adjustment process and become ready for shipment to the user. It is configured so as to operate in the host mode and function as a host apparatus. In the host mode, the parent magnetic disk drive functions as a bus master that directly controls a bus in the data transmission path. In the present embodiment, the device mode is also provided as a magnetic disk drive operation mode in addition to the host mode.

In the device mode, a magnetic disk drive functions as a bus slave, which outputs data to or inputs data from the bus in the data transmission path under the control of the bus master. The device mode is an operation mode for the user. The host mode is a special operation mode that is used by the present embodiment for test/adjustment purposes. For test/adjustment purposes, the parent magnetic disk drive 340 operates in the host mode. However, when the parent magnetic disk drive 340 is to be shipped as a product, it is set to operate in the device mode. The structure of a magnetic disk drive operating in the host mode and device mode and a selection between the host mode and device mode will be described later.

The test controller 350 comprises an ATA interface connector 351 for connecting to the parent magnetic disk drive 340, ATA interface connectors 369-1 through 369-n for connecting to child magnetic disk drives #1 through #n, a bus controller 354, bus switches 367-1 through 367-n, and a display panel 371. Within the bus controller 354, an internal bus 365 is connected to a processor (CPU) 353 for controlling the operation of the test controller 350, a nonvolatile memory (ROM) 357 for storing a control program that is to be executed by the CPU 353, and a volatile memory (RAM) 355 for temporarily storing the control program and providing a work area for the CPU 353.

The internal bus 365 is also connected to an interface 361, which comprises, for instance, ATA registers and built-in buffer for exchanging commands, data, programs, and the like with the parent magnetic disk drive 340, and to a controller 359 for generating control signals for bus switches 367-1 through 367-n. The controller 359 is controlled by the CPU 353.

The ATA registers in the interface 361 include an 8-bit status register, which contains, for instance, a busy (BSY) bit, data request (DRQ) bit, and an error (ERR) bit; a command register for writing an 8-bit command code; and an 8-bit device/head register having a device selection (DEV) bit.

The bus controller 354 includes a jumper 363, which serves as a device setup section for defining the test controller 350 as a master or slave. The jumper 363 is connected to the CPU 353. When the jumper block connection location is changed, the jumper 363 applies a certain potential, which gives a logic 1, to the CPU 353 or applies a ground potential, which gives a logic 0, to the CPU 353 to indicate whether the test controller 350 is a master or slave according to the ATA standard. In the present embodiment, the jumper 363 is set to a logic 1 so that the test controller 350 serves as a slave (ID=1). Child magnetic disk drives #1 through #n are defined as a master (ID=0) by mounting the same jumper block on them.

When the parent magnetic disk drive 340 sets the DEV bit of the device/head register in the interface 361 to 1 and sends a command to the test controller 350, the CPU 353 confirms that the logic given by the jumper 363 coincides with the DEV bit logic, recognizes that it is to be accessed, and executes the command. In this instance, the DEV bit of the device/head register of child magnetic disk drive #X, which corresponds to a closed bus switch, is also set to 1. However, the processor of child magnetic disk drive #X ignores the command because the logic set by the jumper block does not agree with the DEV bit logic.

When the DEV bit of the device/head register is set to 0 for the purpose of allowing the parent magnetic disk drive 340 to send a command to child magnetic disk drive #X, the DEV bit of the device/head register of the interface 361 is also set to 0. However, the CPU 353 references the setting for the jumper 363, recognizes that it is not selected, and ignores the command.

One end of an ATA cable 352 is connected to the ATA interface connector 351 whereas the other end is connected to the interface 361. The ATA cable connected to the interface connector 351 branches to n lines, which are respectively connected to bus switches 367-1 through 367-n. Bus switches 367-1 through 367-n are respectively connected to ATA interface connectors 369-1 through 369-n. Control lines 373 are connected between the controller 359 and bus switches 367-1 through 367-n so that the operations of bus switches 367-1 through 367-n may be controlled by applying a voltage to the control lines 373.

The display panel 371 is connected to the controller 359 to display information about test/adjustment program execution. For execution information display purposes, the display panel 371 indicates, for instance, the numbers of the test/adjustment program phases that are currently executed by child magnetic disk drives #1 through #n, an error encountered during execution, and the completion of a child magnetic disk drive test/adjustment.

Test/Adjustment Procedure for ATA Magnetic Disk Drives

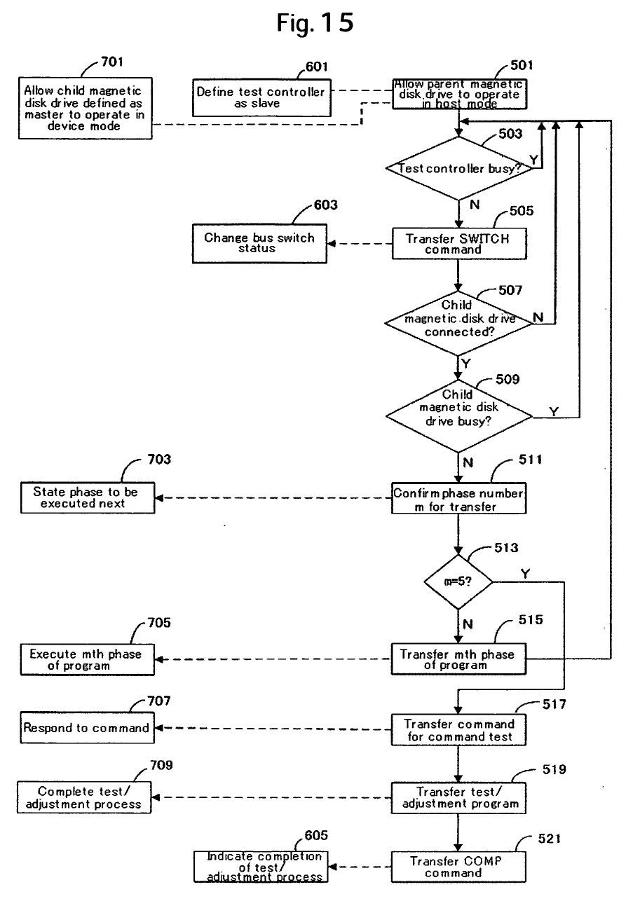

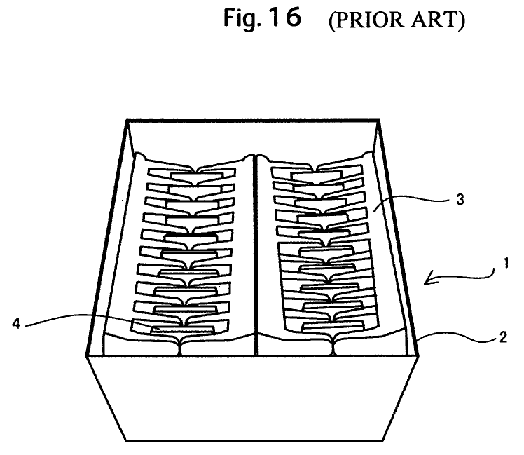

The method for testing/adjusting child magnetic disk drives #1 through #n while the parent magnetic disk drive 340 and child magnetic disk drives #1 through #n are connected to the test controller 350 will now be described with reference to FIG. 15. The configurations of the parent magnetic disk drive 340 and child magnetic disk drives #1 through #n will not be described because they are virtually the same as the configuration of the magnetic disk drive 10 described with reference to FIG. 1. The parent magnetic disk drive and child magnetic disk drives conform to the ATA interface standard and have ATA interface connectors. When the magnetic disk drives have gone through the test/adjustment process according to the present embodiment and are ready for shipment as finished products, they store the first to fifth phases of the test/adjustment program and the test control program on a magnetic disk, and operate as a parent magnetic disk drive 340 in the host mode. Before the magnetic disk drives go through the test/adjustment process, they operate as child magnetic disk drive #X in the device mode (the symbol #X represents a child magnetic disk drive).

In the following description, child magnetic disk drive #X represents a child magnetic disk drive between #1 and #n. The same rule also applies to interface connectors 369-1 through 369-n and bus switches 367-1 through 367-n. More specifically, interface connector 369-X represents a interface connector between 369-1 and 369-n, whereas bus switch 367-X represents a bus switch between 367-1 and 367-n. Major components of the parent magnetic disk drive 340 and child magnetic disk drive #X are the same as those of the magnetic disk drive 10 shown in FIG. 1. In FIG. 15, steps 501 through 521 are the test/adjustment steps to be performed by the parent magnetic disk drive 340. Steps 601 through 605 describe how the test controller 350 operates in response to the operations of the parent magnetic disk drive 340. Steps 701 through 709 describe how a child magnetic disk drive operates in response to the operations of the parent magnetic disk drive 340.

In step 501, the special jumper block 53 (see FIGS. 1 and 2) is mounted on the parent magnetic disk drive 340. In step 601, the jumper 363 for the test controller is set to a slave (ID=1). In step 701, the general-purpose jumper block 61 (see FIG. 1) is mounted on child magnetic disk drives #1 through #1n. Then, the parent magnetic disk drive 340 and child magnetic disk drives #1 through #n are turned on with the parent magnetic disk drive 340 connected to the interface connector 351 and with child magnetic disk drives #1 through #n connected to interface connectors 369-1 through 369-n. In this instance, child magnetic disk drives #1 through #n need not be connected to all interface connectors 369-1 through 369-n. Some interface connectors may be left unconnected.

The general-purpose jumper block 61 may be set to operate child magnetic disk drives #1 through #n in the device mode or define them as a master (ID=0). The settings for the special jumper block 53 and general-purpose jumper block 61 are reflected in the status register of the MPU 125 via the logic gate 45. Upon power on, the MPU 25 always references the status register. Therefore, the parent magnetic disk drive 340 reads the host mode execution program from the magnetic disk 11 upon power on and loads it into the RAM 39 to operate in the host mode. On the other hand, child magnetic disk drives #1 through #n execute the firmware stored in the ROM to operate in the device mode, which is the same as the mode for use by the user.

When the test controller 350 is set as a slave, it ignores any transmitted command until the parent magnetic disk drive 340 sets the DEV bit of the device/head register to 1. When child magnetic disk drive #X is set as a master, it ignores any transmitted command until the parent magnetic disk drive 340 sets the DEV bit of the device/head register to 0. The test/adjustment program comprises the first to fifth phases as described with reference to FIGS. 12 and 13, and is stored in a system area of the magnetic disk 11 in the parent magnetic disk drive 340.

In step 503, the parent magnetic disk drive 340 executes an ATA device selection protocol to check whether the test controller 350 is idle. The parent magnetic disk drive 340 sets the DEV bit of the device/head register to 1, specifies the address of the test controller 350, specifies an address of the status register, and reads the BSY bit of the test controller's status register. If the BSY bit is 0, it means that the test controller 350 is idle. If the BSY bit is 1, it means that the test controller 350 is busy. When the test controller is busy, the device selection protocol is repeatedly executed until the test controller becomes idle.

While the test controller 350 is busy, it is impossible to receive a command from the parent magnetic disk drive 340 because the bus controller 354 is engaged in bus switching. After verifying that the test controller 350 is idle, the parent magnetic disk drive 340 sends a signal, in step 505, to the ATA cable 352 for the purpose of setting the DEV bit of the device/head register of the interface 361 to 1. If, in this instance, only bus switch 367-n is closed while the other bus switches are open, the DEV bit of the device/head register of child magnetic disk drive #n is also set to 1.

The jumper 363 of the test controller 350 is preset to a logic 1 (ID=1) so that the test controller 350 serves as a slave. Therefore, the CPU 353 references the DEV bit of the device/head register and the logic state of the jumper 363 to recognize that it is selected. On the other hand, child magnetic disk drive #n is preset by the general-purpose jumper block 61 to a logic 0 (ID=0) so as to serve as a master. Therefore, it ignores any transmitted command because it does not recognize that it is selected.

Next, the parent magnetic disk drive 340 sends a SWITCH command, which is a vendor-unique ATA command, to the command register of the interface 361. The CPU 353 may execute the SWITCH command under the control of the control program stored in the ROM 357. In this instance, the SWITCH command is also written into the command register of child magnetic disk drive #n. However, this command is ignored because child magnetic disk drive #n is not selected.

In step 603, the test controller 350 executes the SWITCH command to change the bus switch status. The control program is such that one of bus switches 367-1 through 367-n is always closed. When the CPU 353 executes the SWITCH command, the controller 359 is controlled so as to open a closed bus switch 369-X and close a bus switch 369-X+1 having the next number. In the present embodiment, the control program is such that a bus switch status change cyclically occurs in order from 367-1 to 367-n and then from 367-n to 367-1.

If, for instance, only bus switch 367-n is closed, the controller 359 disables the control line 373 for bus switch 367-n, which is currently enabled in compliance with a command from the CPU 353, and enables the control line 373 for bus switch 367-1. As a result, the number of the closed bus switch is changed by one so that a new communication path is established between the parent magnetic disk drive 340 and child magnetic disk drive #1. In step 603, the test controller 350 effects a control line change and sets a bit in the status register of the interface 361 to indicate the completion of such a change. The parent magnetic disk drive 340 then reads the bit to recognize the completion of the change, and becomes ready to access child magnetic disk drive #1.

In step 507, the parent magnetic disk drive 340 checks whether a child magnetic disk drive is connected to the interface connector 369-1. If it is found that no child magnetic disk drive is connected to the interface connector 369-1, the program flow returns to step 503. In step 503, the parent magnetic disk drive 340 executes the device selection protocol in relation to the test controller 350 and then sends the SWITCH command to exercise control for switching to bus switch 369-2, which has an adjacent number. For determining whether a child magnetic disk drive is connected to interface connector 369-X, the child magnetic disk drive is configured so that the signal line of a vendor-definable ATA cable is pulled up or pulled down. When bus switch 367-X closes, the parent magnetic disk drive 340 checks for the signal line in order to determine whether the child magnetic disk drive is connected to interface connector 369-X.

When child magnetic disk drive #X is connected to interface connector 369-X, the program flow proceeds to step 509. In step 509, the parent magnetic disk drive 340 specifies an address of the device/head register and sets the DEV bit to 0 to select child magnetic disk drive #X. Further, the parent magnetic disk drive 340 executes the device selection protocol to check whether child magnetic disk drive #X is busy or idle. Child magnetic disk drives #1 through #n are all slaves (ID=1). However, only bus switch 367-X is closed. Therefore, the parent magnetic disk drive 340 references only the status register of child magnetic disk drive #X.

When the BSY bit of the status register is 1, it means that child magnetic disk drive #X is busy. In this instance, the parent magnetic disk drive 340 returns to step 503, executes the device selection protocol in relation to the test controller 350, and sends the SWITCH command to change the bus switch status. If the BSY bit of the status register is 0, it means that child magnetic disk drive #X is idle. Therefore, the program flow proceeds to step 511. In step 511, the parent magnetic disk drive 340 confirms the phase number of the test/adjustment program that is requested by child magnetic disk drive #X.

At an early test/adjustment stage in step 703, child magnetic disk drive #X sets a bit in the status register for the purpose of identifying the first phase of the test/adjustment program, which the parent magnetic disk drive 340 is to be requested to offer. When the first phase of the test/adjustment program is completely executed, child magnetic disk drive #X erases the first phase of the test/adjustment program from the RAM and becomes ready to receive the second phase of the test/adjustment program from the parent magnetic disk drive 340 and store it in the RAM. To receive and store the second phase of the test/adjustment program, child magnetic disk drive #X sets the BSY bit of the status register to 0 to state that it is idle, and then sets a bit in the status register to identify the number 2, which is the phase number of the test/adjustment program to be transferred next by the parent magnetic disk drive 340. The bit to be set in the status register may represent the number of a phase that was completed last or the number of the phase to be requested next.

The time required for executing each phase of the test/adjustment program varies with the manufacture-dependent characteristics of magnetic disk drive #X. Therefore, no one knows which child magnetic disk drive completes each phase of the test/adjustment program at the highest speed. In step 703, child magnetic disk drives #1 through #n set a bit in the status register to indicate the phase number of the test/adjustment program to be requested next when the last-transmitted test/adjustment program is completely executed, and wait until the corresponding bus switch closes and they are selected by the parent magnetic disk drive 340.

When the parent magnetic disk drive 340 has referenced the status register and confirmed that the phase number of the test/adjustment program requested by child magnetic disk drive #X is m, the program flow proceeds to step 513. Step 513 is performed to check whether the phase number m is 5, which is the phase number of the command test. If the phase number m is 4 or lower, the program flow proceeds to step 515. In step 515, the parent magnetic disk drive 340 transfers the mth phase of the test/adjustment program to child magnetic disk drive #X, and also transfers a START command, which is a vendor-unique ATA command, to start executing the mth phase of the test/adjustment program.

In step 705, child magnetic disk drive #X cannot use the magnetic disk for storing the mth phase of the test/adjustment program. However, the mth phase of the test/adjustment program is sized so that it may be stored in the RAM. Therefore, the MPU of child magnetic disk drive #X executes the test program stored in the ROM to store the mth phase of the test/adjustment program in the RAM. Further, child magnetic disk drive #X receives the START command from the parent magnetic disk drive 340 and starts executing the mth phase of the test/adjustment program. While the mth phase of the test/adjustment program is being executed, child magnetic disk drive #X sets the BSY bit of the status register to 1 to state that it is busy at the present time.

When the parent magnetic disk drive 340 transferred the mth phase of the test/adjustment program to child magnetic disk drive #X and transmitted the START command, the program flow returns to step 503. In step 503, the parent magnetic disk drive 340 transfers a proper phase of the test/adjustment program in compliance with the request from another child magnetic disk drive and allows the program to be executed. To do so, the parent magnetic disk drive 340 repeats steps 503 through 515. More specifically, the parent magnetic disk dive 340 sequentially sends the SWITCH command to the test controller 350 to change the bus switch status and detects an idle child magnetic disk drive. When the parent magnetic disk drive 340 detects that a child magnetic disk drive is idle, the parent magnetic disk drive 340 reads its status register, recognizes the number of the phase of the test/adjustment program to be requested next, and transfers the program and then the START command. If, in this instance, the interface connector is left unconnected or the BSY bit of the child magnetic disk drive's status register is found to be 1, the program flow returns to step 503. In step 503, the SWITCH command is transmitted to the test controller 350.

As described above, steps 503 through 515 are performed to sequentially transfer the first to fourth phases of the test/adjustment program to child magnetic disk drives #1 through #n, which are connected to the test controller 350, so that program execution starts in child magnetic disk drives #1 through #n. While child magnetic disk drive #X executes the first to fourth phases of the test/adjustment program, the parent magnetic disk drive 340 does not need to communicate with child magnetic disk drive #X. Therefore, the parent magnetic disk drive 340 may transfer the test/adjustment program to a plurality of child magnetic disk drives #1 through #n and allow child magnetic disk drives #1 through #n to simultaneously execute the test/adjustment program for test/adjustment purposes.

If, in step 513, the parent magnetic disk drive 340 detects that the fifth phase of the test/adjustment program is to be requested by child magnetic disk drive #X, which is a child magnetic disk drive between #1 and #n, the parent magnetic disk drive 340 performs step 517 to transfer a command for performing the command test to child magnetic disk drive #X. For command testing purposes, the parent magnetic disk drive 340 executes the fifth phase of the test/adjustment program to transfer a command to child magnetic disk drive #X, confirm the contents of various registers, and read data.

In the command test, the parent magnetic disk drive 340 transmits a read/write command, which is based on predicted user operations, to child magnetic disk drive #X to check whether predefined operations are performed. For example, a write command is transmitted to write data and then a read command is transmitted to read the written data. In step 707, child magnetic disk drive #X executes various commands, sets the obtained execution results in various registers, and writes data into a buffer. The parent magnetic disk drive 340 confirms the ERR (error) bit of the status register and the bits of an error register to check whether an error has occurred in child magnetic disk drive #X. Further, the parent magnetic disk drive 340 checks whether read data agrees with the written data.

When the command test is performed, child magnetic disk drive #X may be inspected, including its interface system, in an environment that is close to a user operating environment. As a result, the quality assurance capability may be increased. While the command test is being performed on one child magnetic disk drive #X, the parent magnetic disk drive 340 does not issue the SWITCH command to the test controller 350. After step 517 is performed to complete the command test, child magnetic disk drive #X is finished as a product having complete functions and ready for shipment.

In step 519, the parent magnetic disk drive 340 transfers the test/adjustment program, test control program, and host mode execution program, which are stored in the system area of the local magnetic disk, to child magnetic disk drive #X, which has gone through the command test. In step 709, child magnetic disk drive #X stores the above programs in the system area of its magnetic disk to complete the test/adjustment process. Child magnetic disk drive #X now functions as a new parent magnetic disk drive and may perform the test/adjustment process on another child magnetic disk drive. If child magnetic disk drive #X is to be shipped to the market without using it as a parent magnetic disk drive, step 519 need not be performed.

After completion of test/adjustment program transfer, the parent magnetic disk drive 340 performs step 521 to send a COMP command, which is a vendor-unique ATA command, to the test controller 350. In step 605, the test controller 350 causes the display panel 371 to indicate the completion of the test/adjustment process. When the COMP command is executed, the CPU 353 of the test controller 350 recognizes the number 367-X of a currently closed bus switch and causes the display panel 371 to indicate that the test/adjustment process is completed for child magnetic disk drive #X, which is connected to the ATA interface connector 369-X related to the currently closed bus switch. In the present example, the display panel 371 reads, for instance, “367-X test/adjustment process completed”. Child magnetic disk drives #1 through #n do not have specific identifiers. Therefore, the number of a closed bus switch is used to specify a child magnetic disk drive.

If an error occurs in child magnetic disk drive #X while the first, second, third, or fourth phase of the test/adjustment program is being executed, child magnetic disk drive #X halts the program execution, informs the parent magnetic disk drive 340 that the program execution is halted, and sets the BSY bit of the status register to 0. For informing the parent magnetic disk drive 340 of an error occurrence, the child magnetic disk drive is configured so that the signal line of a vendor-definable ATA cable is pulled up or pulled down. When a bus switch corresponding to the magnetic disk drive closes, the parent magnetic disk drive 340 confirms the signal line to check for the above error occurrence. Alternatively, the parent magnetic disk drive 340 may be informed of the above error occurrence by setting a bit in the status register or ERROR register.

When the parent magnetic disk drive 340 confirms that an error has occurred in child magnetic disk drive #X, an ERROR command, which is a vendor-unique ATA command, is transmitted to the test controller 350. When the ERROR command is executed, the CPU 353 of the test controller 350 recognizes that an error has occurred in a child magnetic disk drive that is connected to an interface connector corresponding to a currently closed bus switch, and controls the controller 359 to display error information on the display panel 371. The error information displayed on the display panel 371 reads, for instance, “367-X error”.

When the parent magnetic disk drive 340 transfers the first, second, third, fourth, or fifth phase of the test/adjustment program to child magnetic disk drive #X, it may notify the test controller 350 of the number of the phase to be transferred. The test controller 350 then recognizes child magnetic disk drive #X, which is at the destination, as bus switch 367-X. Therefore, the test controller 350 may recognize that child magnetic disk drive #X, which is connected to interface connector 369-X, is executing the above-mentioned phase of the test/adjustment program. The test controller 350 uses such information to display the associated bus switch number and transferred test/adjustment program phase numbers on the display panel 371 for the purpose of displaying the information about test/adjustment program execution for magnetic disk drives #1 through #n. The program execution information displayed on the display panel 371 reads, for instance, “367-X phase 3”.

Description of a Manufacturing Process that is Performed Between Magnetic Disk Drive Assembly Completion and Shipment

Description of a Transport Container

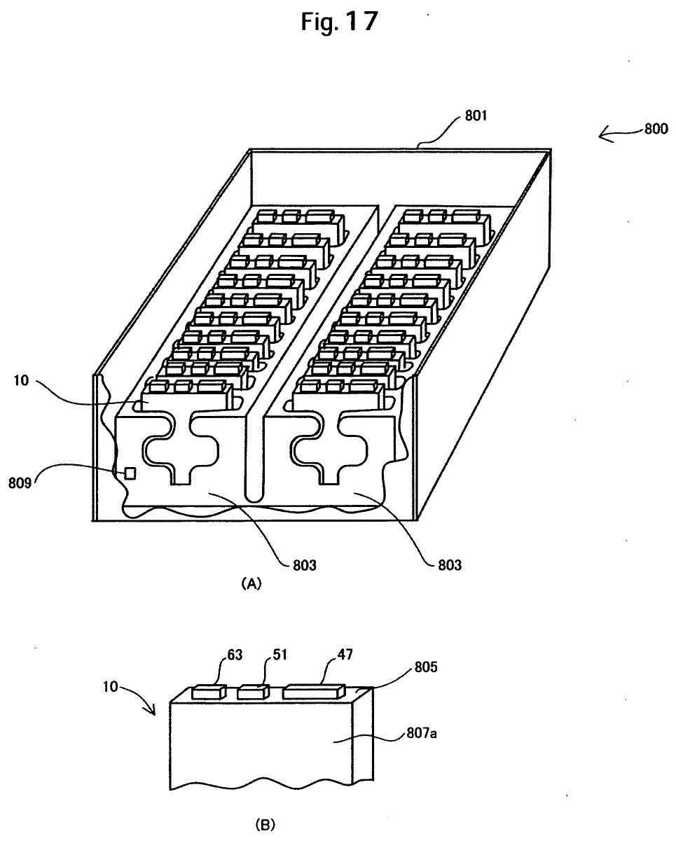

FIGS. 17(A) and 17(B) illustrate a plurality of assembled magnetic disk drives 10 (see FIGS. 1 and 2) that are packed into a transport container 800, which is used in a manufacturing process according to the present embodiment. The magnetic disk drives 10 conform to the ATA interface standard. The transport container 800 comprises a corrugated cardboard box 801 and a shock absorber 803. The transport container 800 contains twenty magnetic disk drives 10, which is a typical unit of transport. The shock absorber 803 protects the magnetic disk drives 10 against shock and vibration while they are shipped from factory to user.

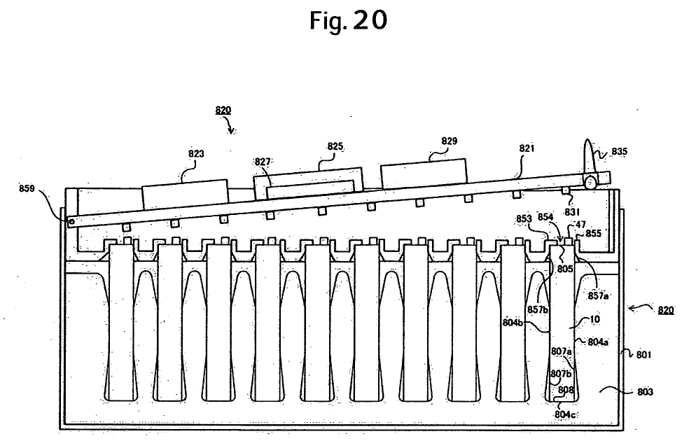

The corrugated cardboard box 801 is the same as that used for the conventional transport container. However, the shock absorber 803 has compartments for individually holding the magnetic disk drives 10 whose interface connector 47, jumper connector 51, and power supply connector 63 face upward. A lateral surface 805 of the enclosure on which the interface connector 47 and the like are mounted and some portions of enclosure surfaces 807a, 807b (see FIG. 20 for 807b) that are parallel to the magnetic disk 11 are exposed from the upper end face of the shock absorber 803.

The shock absorber 803 is made of a plastic material to which a conductive material is added, and formed in such a manner that it is hollow. The shock absorber 803 is rendered conductive to prevent a potential from arising between the enclosure of a magnetic disk drive and a circuit board mounted on the enclosure even when static electricity is generated during transit. In this manner, semiconductor devices on the circuit board are protected from being damaged by static discharge.

An alternative is to use a shock absorber 803 made of a nonconductive material instead of using a conductive shock absorber, and insert the magnetic disk drives 10 into the compartments while they are placed in conductive bags. An RFID (radio-frequency identification system) tag 809 is attached to the shock absorber 803.

Description of a Test/Adjustment Apparatus

According to the present embodiment, the transport container 800 is used in the second and third magnetic disk drive manufacturing processes. The second manufacturing process is performed to incorporate functions as the test/adjustment process to be performed after completion of magnetic disk drive assembly. The third manufacturing process is performed for packing purposes. In the function incorporation process, the host apparatus is connected to a magnetic disk drive for the purpose of writing servo information onto the magnetic disk by the self servo write method, adjusting control circuit parameters, and performing other test/adjustment procedures. Further, the host apparatus transfers a program to the magnetic disk drive, and then the magnetic disk drive targeted for the test/adjustment process locally executes the received program for test/adjustment purposes. Alternatively, the command test is performed while the host apparatus communicates with the magnetic disk drive.

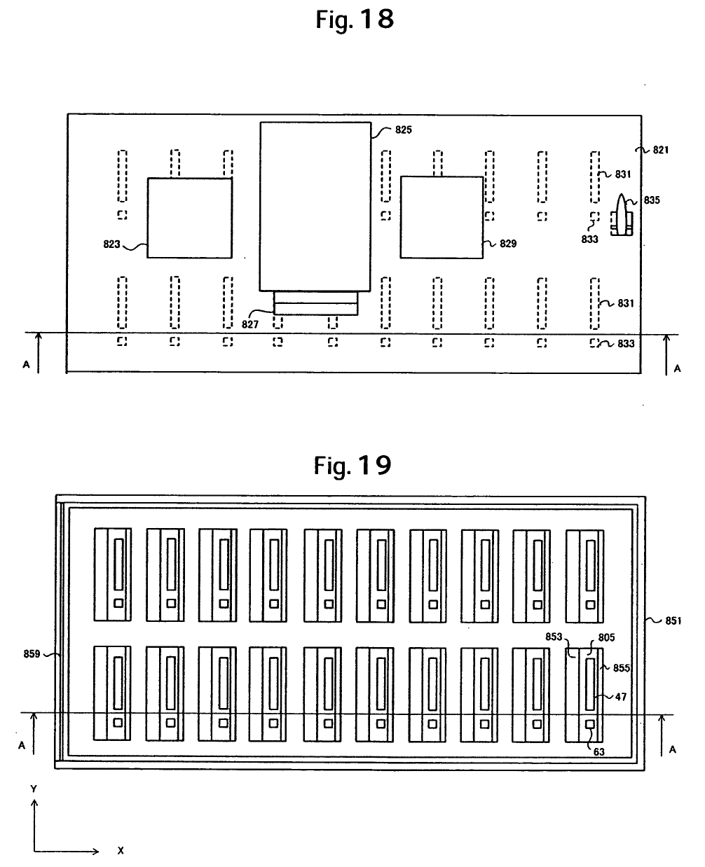

When the above test/adjustment process is performed while a plurality of magnetic disk drives are set in the transport container 800, the magnetic disk drives will not possibly bump against something or drop to suffer impact unlike in a situation where they are handled on an individual basis. Consequently, the yield rate increases. Further, a plurality of magnetic disk drives may be managed on an individual transport container basis during the manufacturing processes. This ensures that management information may be simplified. A test/adjustment apparatus 820 for performing the test/adjustment process described above will now be described with reference to FIGS. 18 through 20.

FIG. 18 is a plan view illustrating a base plate 821, which composes the test/adjustment apparatus 820. FIG. 19 is a plan view illustrating a guide plate 851, which also composes the test/adjustment apparatus 820. FIG. 20 is a cross-sectional view illustrating the test/adjustment apparatus 820, which is a combination of the base plate 821 and guide plate 851, and the transport container 800. FIG. 20 shows section A-A of FIGS. 18 and 19. Referring to FIG. 18, a test controller 823, a host side connector 827, a parent magnetic disk drive 825, and an RFID reader/writer 829 are mounted on the surface of the base plate 821. The surface of the base plate 821 is also provided with a separation lever 835. Mounted on the rear surface of the base plate 821 are testing side connectors 831 and testing side power supply connectors 833. Ten testing side connectors 831 and ten testing side power supply connectors 833 are arranged in the X-direction. Two rows of these connectors are arranged in the Y-direction. In total, twenty sets of these connectors are mounted. In FIG. 20, reference numbers are assigned only to a typical testing side connector 831 and to a typical testing side power supply connector 833. One of the twenty testing side connectors 831 may be handled as the host side connector 827. In such an instance, the parent magnetic disk drive 825 is placed in the transport container 800 and connected to the host side connector 827.

The test controller 823 is configured the same as the test controller 350 described with reference to FIG. 14 except that the former does not include interface connectors 369-1 through 369-n or interface connector 351. Therefore, the test controller 823 includes the bus controller 354, bus switches 367-1 through 367-n, and display panel 371. The testing side connectors 831 correspond to interface connectors 369-1 through 369-n, which are described with reference to FIG. 14. The parent magnetic disk drive 825 corresponds to the parent magnetic disk drive 340 described with reference to FIG. 14. The RFID reader/writer 829 is connected to the controller 354 in the test controller 823 and may read the data stored in the ROM 357 and write it into the tag 809 (see FIG. 17) or read the data written in the tag 809 and write it into the ROM 357.

Referring to FIG. 19, the guide plate 851 is positioned beneath the base plate 821 and supported by a rotation shaft 859 so as to turn the base plate 821. The guide plate 851 is provided so that the positions of the interface connector 47 and power supply connector 63 of the magnetic disk drive 10 described with reference to FIG. 17 match the positions of the base-plate-mounted testing side connectors 831 and testing side power supply connectors 833 in both the X- and Y-directions.

The guide plate 851 is provided with a through-hole 854 (see FIG. 20) so that the interface connector 47 and power supply connector 63 of the magnetic disk drive are aligned and exposed. A guide section 855 and a pressure section 853 are formed on the X-direction rim of the through-hole 854. The guide section 855 is in contact with an enclosure surface 807a that is parallel to the magnetic disk, and determines the position of the magnetic disk drive 10. The pressure section 853 comprises a vertical section and a horizontal section. The vertical section determines the position of an enclosure surface 807b that is parallel to the magnetic disk. The horizontal section prevents the magnetic disk drive from moving upward when the test/adjustment apparatus 820 is removed.

The horizontal section is in contact with the lateral surface 805 that is on the interface connector side of the magnetic disk drive 10. Sloped surfaces are formed on the guide plate surface positioned toward the shock absorber 803. More specifically, sloped guide surfaces 857a, 857b are formed on the X-direction rim of the through-hole 854. Sloped surfaces (not shown) are also formed on the Y-direction rim of the through-hole 854. When each through-hole 854 of the guide plate 851 is fitted onto the top of each magnetic disk drive 10, each magnetic disk drive 10 is properly positioned because its enclosure readily fits into the through-hole 854 due to the sloped surfaces formed on the rim of the through-hole 854. The structures of the pressure section 853, guide section 855, sloped guide surface, and through-hole 854 remain the same at positions corresponding to any magnetic disk drives. To secure the magnetic disk drive 10, the surfaces 807a, 807b parallel to the magnetic disk, a lateral surface 854 on the interface connector side, and the opposite lateral surface 808 are held within a compartment that is formed by the sidewalls 804a, 804b and bottom 804c of the shock absorber 803.

The test/adjustment apparatus 820 that has been described above is suitable for testing/adjusting magnetic disk drives 10 conforming to the ATA interface standard. However, the test/adjustment apparatus 820 according to the present invention is also suitable for testing/adjusting magnetic disk drives conforming to the SCSI standard or Fibre Channel standard. When magnetic disk drives conforming to the SCSI standard or Fibre Channel standard are to be tested/adjusted, the test controller 823 is not required; however, the host side connector should be connected to an SCSI transmission path or a transmission path containing a Fibre Channel arbitrated loop or Fibre Channel fabric switch.

Description of a Magnetic Disk Drive Manufacturing Method

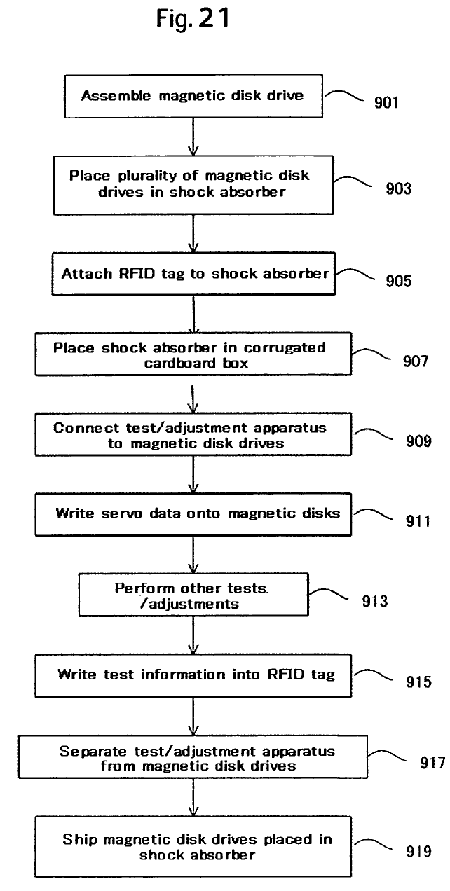

A method for manufacturing a magnetic disk drive 10 with the transport container 800 and test/adjustment apparatus 820 will now be described with reference to a flowchart in FIG. 21. Step 901 is performed to mount the components of the magnetic disk drive 10 on a base by a known method and install a base cover over the base. Further, a circuit board, which carries communication and control semiconductor devices, is mounted on an enclosure to complete the hardware configuration of the magnetic disk drive 10.

In step 903, the compartments in the shock absorber 803 are used to retain, for instance, twenty magnetic disk drives 10 with the interface connector 47 facing upward as shown in FIG. 17. For each magnetic disk drive 10, the general-purpose jumper block 61 is mounted on the jumper connector 51. As described earlier, when a parent magnetic disk drive is to be placed in the transport container 800, the special jumper block 53 is mounted on one of the twenty magnetic disk drives to permit host mode operations. In step 905, the RFID tag 809 is attached to the shock absorber 803. In step 907, the shock absorber 803, which retains the twenty magnetic disk drives 10, is placed in the corrugated cardboard box 801. A barcode label may be attached to the corrugated cardboard box 801 to indicate the delivery destination, apparatus identification number, quantity, and other information that does not change during subsequent processes including the shipment process.

In step 909, the twenty magnetic disk drives 10 contained in the transport container 800 are connected to the test/adjustment apparatus 820. More specifically, the guide plate 851 of the test/adjustment apparatus 820 is installed from the interface connector side of the magnetic disk drives 10 so as to fit the magnetic disk drives 10 into the twenty through-holes 854 and adjust the positions of the interface connector 47 and power supply connector 63 for those of the testing side connectors 831 and testing side power supply connectors 833. If, in this instance, any magnetic disk drive 10, which is within a compartment in the shock absorber 803, is slightly displaced in the XY-direction, the sloped guide surfaces cause the magnetic disk drive enclosure to smoothly fit into the associated through-hole 854.

Next, the base plate 821 is turned on the rotation shaft 859 to connect the testing side connector 831 to the interface connector 47 and the testing side power supply connector 833 to the power supply connector 63. The special jumper block 53 is mounted on the parent magnetic disk drive 825 so that the parent magnetic disk drive 825 operates in the host mode. In step 911, the program for writing servo information onto each magnetic disk is transferred from the parent magnetic disk drive 825 to each magnetic disk drive 10. Each magnetic disk drive executes the transferred program to write servo information by the self servo write method.

In step 913, another test/adjustment program is transferred from the parent magnetic disk drive 825 and executed by each magnetic disk drive 10 or the parent magnetic disk drive 825 sends a command directly to each magnetic disk drive 10 to perform another test/adjustment. In steps 911 and 913, a magnetic disk drive 10 to which a test/adjustment program is transferred from the parent magnetic disk drive 825 locally executes the program to perform a test/adjustment process. After completion of test/adjustment program transfer, therefore, the test/adjustment apparatus 820 does not require the test controller 823 and parent magnetic disk drive 825. Consequently, the test/adjustment apparatus 820 may be replaced with the one having a power supply function only.

If a program execution in step 911 or 913 is faulty in a certain magnetic disk drive, the RFID reader/writer receives information from the test controller 823 in step 915 and writes the error information about the affected magnetic disk drive into the RFID tag. Further, the information about the progress in magnetic disk drive test/adjustment is written into the RFID tag as needed.

The use of the RFID tag for information management concerning the manufacturing method according to the present invention is more beneficial than the use of a conventional barcode. If, for instance, the test/adjustment process is to be continuously performed with the test/adjustment apparatus 820 replaced with the one having a different function, the RFID reader of the newly employed test/adjustment apparatus may read the previous progress information from the RFID tag and use the read information for subsequent tests/adjustments. Consequently, test/adjustment management may be exercised with increased ease. The manufacturing method according to the present invention does not require any dedicated transport line for test/adjustment use, and may perform tests/adjustments while many transport containers 800, in which magnetic disk drives are contained, are arranged within a large space. The use of the RFID tag in the above environment provides an advantage. More specifically, it is possible to dynamically write the test/adjustment progress information and error occurrence information about each transport container 800 into the RFID tag, read the written information with an RFID reader that is installed at an appropriate place, and timely exercise inventory management and issue a manufacture report to the user. Further, it is possible to wait for shipment without adding barcoded information or the like to a transport container that has gone through the test/adjustment process. Even when the transport container is mounted on a pallet, necessary information may easily be read from the RFID tag.

The twenty magnetic disk drives 10 will not be removed from the transport container unless the test/adjustment process is unsuccessful. The information about the manufacture of the twenty magnetic disk drives may be managed simply by attaching one RFID tag to the shock absorber 803 or corrugated cardboard box 801. The cost is lower than in a situation where the RFID tag is attached to each magnetic disk drive 10.

In step 917, the test/adjustment apparatus 820 is removed from the transport container 800. The separation lever 835 is operated to press its lower end against the surface of the guide plate 851, separate the base plate 821 from the guide plate 851, and remove the testing side connectors 831 and testing side power supply connectors 833. In this instance, the horizontal portion of the pressure section 853 presses the interface side lateral surface 805 of the magnetic disk drive 10 to prevent the magnetic disk drive 10 from rising.

In step 919, the corrugated cardboard 801 is covered and packed for shipment to the user. When steps 901 through 917 are followed to perform a magnetic disk drive manufacturing process, the magnetic disk drives 10 held by the shock absorber 803 are not removed from the transport container 800 until they are shipped. Therefore, the magnetic disk drives 10 are not likely to bump against something or drop to become defective.

When the transport container 800 according to the present embodiment is used, it is possible to test the magnetic disk drives at a high ambient temperature by making use of heat that is generated when the magnetic disk drives contained in the transport container operate. In this instance, the transport container heat storage effect may be easily enhanced by covering the external surface of the transport container 800 with a skirt-shaped vinyl sheet. When the magnetic disk drives are tested at a high ambient temperature, it is possible to detect the cause of an initial failure by applying thermal stress to the magnetic disk drives. At a high temperature, for example, the magnetic head may suffer thermal expansion, which is known as thermal protrusion. More specifically, the magnetic head may bump against dirt on the magnetic disk surface or a convex of the magnetic disk. The affected area of the magnetic disk may then become unavailable for data recording. When testing is conducted at a high ambient temperature to invoke such a phenomenon and register a sector unavailable for magnetic disk recording as a defect, it is possible to avoid a defect that may arise after shipment.

While the present invention has been described in detail in conjunction with specific embodiments, persons of skill in the art will appreciate that variations may be made without departure from the scope and spirit of the present invention. The described embodiments are to be considered in all respects only as illustrative and not restrictive. The scope of the invention is, therefore, indicated by the appended claims rather than by the foregoing description.

What is claimed is:

1. A manufacturing method for manufacturing a magnetic disk drive equipped with an interface connector, the manufacturing method comprising:
holding a plurality of magnetic disk drives with a shock absorber so that the interface connector of each magnetic disk drive is exposed;
connecting a plurality of testing side connectors, which are arranged to match interface connectors of the held magnetic disk drives, to the interface connectors;
transferring a test/adjustment program from a host apparatus to the magnetic disk drives via the testing side connectors; and
being executed the test/adjustment program by the magnetic disk drives.

2. The manufacturing method according to claim 1, wherein the test/adjustment program includes a program for writing servo information onto a magnetic disk.

3. The manufacturing method according to claim 1, wherein the test/adjustment program includes a program that sends a command to the magnetic disk drives and causes the magnetic disk drives to execute the command.

4. The manufacturing method according to claim 1, wherein the host apparatus is a magnetic disk drive that operates in a host mode.

5. The manufacturing method according to claim 1, wherein the shock absorber has an RFID tag, and further comprising writing the test/adjustment information about the magnetic disk drives onto the RFID tag.

6. The manufacturing method according to claim 1, wherein the magnetic disk drives and the shock absorber are contained in a shipment transport box while the magnetic disk drives are executing the test/adjustment program.

7. The manufacturing method according to claim 1, further comprising performing, after the test/adjustment program is completely executed by each of the magnetic disk drives, a packing procedure while the shock absorber, which retains the magnetic disk drives, is placed in the shipment transport box.

8. A test/adjustment apparatus for testing a plurality of magnetic disk drives whose interface connectors are aligned in the same direction, the test/adjustment apparatus comprising:
a base plate;
a plurality of testing side connectors mounted on one surface of the base plate to match the interface connectors and connectable to the interface connectors;
a host side connector connected to each of the testing side connectors and mounted on the base plate so as to be connectable to a host apparatus; and
a guide plate configured to prescribe the positions of the interface connectors, which correspond to the positions of the testing side connectors.

9. The test/adjustment apparatus according to claim 8, further comprising a test controller having a plurality of bus switches that operates in compliance with an ATA command, and connects the testing side connectors and the host side connector.

10. The test/adjustment apparatus according to claim 8, wherein the host apparatus is a magnetic disk drive that operates in a host mode.

11. The test/adjustment apparatus according to claim 10, wherein the host side connector is flush with the base plate on which the testing side connectors are mounted.

12. The test/adjustment apparatus according to claim 8, wherein the host side connector is connected to an SCSI transmission path.

13. The test/adjustment apparatus according to claim 8, wherein the host side connector is connected to a transmission path containing a Fibre Channel arbitrated loop or a Fibre Channel fabric switch.

14. The test/adjustment apparatus according to claim 8, wherein the plurality of magnetic disk drives are held by a shock absorber so that the interface connectors are exposed.

15. The test/adjustment apparatus according to claim 14, wherein, when the testing side connectors and the interface connectors are connected, the shock absorber for retaining the magnetic disk drives is placed in a shipment transport box for the magnetic disk drives.

16. The test/adjustment apparatus according to claim 8, wherein the guide plate includes a pressure section for preventing the magnetic disk drives from rising when the testing side connectors are disconnected from the interface connectors.

17. The test/adjustment apparatus according to claim 8, wherein the guide plate includes a through-hole for the interface connectors of the magnetic disk drives and a sloped guide surface around the through-hole.

18. The test/adjustment apparatus according to claim 8, further comprising an RFID writer.

19. A transport container for use in the manufacture and shipment of a magnetic disk drive that has an interface connector on a lateral surface of a disk enclosure, the transport container comprising:
a shock absorber configured to hold a plurality of magnetic disk drives so that the interface connector protrudes above an upper end; and
a shipment transport box configured to contain the shock absorber for holding the plurality of magnetic disk drives.

20. The transport container according to claim 19, wherein an RFID tag is attached to the shock absorber or the shipment transport box.
